(19) United States
(12) Patent Application Publication
(10) Pub. No.: US 2017/0220748 A1
(43) Pub. Date: Aug. 3, 2017

(54) MEDICAL SUPPORT APPARATUS AND SYSTEM, AND NON-TRANSITORY COMPUTER READABLE MEDIUM

(71) Applicant: FUJIFILM Corporation, Tokyo (JP)

(72) Inventors: Yuki OKABE, Tokyo (JP); Rena KAMODA, Tokyo (JP)

(73) Assignee: FUJIFILM Corporation, Tokyo (JP)

(21) Appl. No.: 15/375,494

(22) Filed: Dec. 12, 2016

(30) Foreign Application Priority Data
Jan. 28, 2016 (JP) 2016-013941

(51) Int. Cl. G06F 19/00; G06F 21/62

(52) U.S. Cl. CPC G06F 19/345; G06F 19/321; G06F 19/322; G06F 21/6245; G06F 19/3406

(57) ABSTRACT

A medical support apparatus includes a first acquisition unit for acquiring activity log data of a user activity related to a test result from a display terminal apparatus for displaying a test result of a diagnostic test performed to a patient body. A second acquisition unit acquires message data of a message transmitted between medical user terminal apparatuses from the medical user terminal apparatuses used by medical workers, such as a doctor. A data manager registers the activity log data and the message data to a storage medium in a manner associated with one another. A display output control unit performs display control of a record log screen having a group screen area for displaying the activity log data and the message data together after being associated by the data manager.

### CROSS-REFERENCE TO RELATED APPLICATION

This application claims priority under 35 USC 119 from Japanese Patent Application No. 2016-013941, filed 28 Jan. 2016, the disclosure of which is incorporated by reference herein.

### BACKGROUND OF THE INVENTION

1. Field of the Invention

The present invention relates to a medical support apparatus and system, and a non-transitory computer readable medium. More particularly, the present invention relates to a medical support apparatus and system in which information of a user activity related to a diagnostic test for a patient, and messages between plural terminal apparatuses are displayed, and a causal relationship between the information of the user activity and the messages can be recognized reliably, and a non-transitory computer readable medium.

2. Description Related to the Prior Art

A medical support apparatus for providing medical care data to a doctor or medical worker is known in the field of medical instruments, in order to support medical care of the doctor by utilizing the acquired medical care information in the course of diagnosis and treatment of a patient. For example, JP-A 2008-225712 discloses a medical support apparatus in which activity log data is displayed according to a history of a user activity related to a test result of a diagnostic test performed to the patient. JP-A 2015-043125 discloses a medical support apparatus in which message data of messages is displayed after exchanging the messages between plural medical user terminal apparatuses used by plural medical workers inclusive of doctors, nurses and the like.

The user activities related to the test results include enlargement for displaying a diagnostic image by clicking its thumbnail image after forming by performing medical imaging of a patient body. An example of the message is a reminder from a physician to a radiologist for encouraging image interpretation of the diagnostic image. The radiologist upon receiving the message for encouraging the image interpretation from the physician clicks the thumbnail image of the diagnostic image of interest, and carefully observes the enlarged diagnostic image to perform the image interpretation.

In JP-A 2008-225712 and JP-A 2015-043125, only the activity log data or only the message data is displayed. However, a causal relationship between the activity log data and the message data is not considered, and cannot be readily reviewed.

A causal relationship lies between the user activity and the message. However, there is no known system for facilitating understanding of the causal relationship on a side of a doctor or medical worker between the message and the user activity performed on the basis of the message, so that progress of medical care cannot be reviewed rapidly and suitably, and steps of the medical care cannot be tracked with high efficiency.

### SUMMARY OF THE INVENTION

In view of the foregoing problems, an object of the present invention is to provide a medical support apparatus and system in which information of a user activity related to a diagnostic test for a patient, and messages between plural medical user terminal apparatuses are displayed, and a causal relationship between the information of the user activity and the messages can be recognized reliably, and a non-transitory computer readable medium.

In order to achieve the above and other objects and advantages of this invention, a medical support apparatus includes a first acquisition unit for acquiring activity log data of a user activity related to a test result from a display terminal apparatus for displaying a test result of a diagnostic test performed to a patient body. A second acquisition unit acquires message data of a message transmitted between medical user terminal apparatuses from the medical user terminal apparatuses used by medical workers. A data manager registers the activity log data and the message data to a storage medium in a manner associated with one another. A display output control unit performs display control of a record log screen having a group screen area for displaying the activity log data and the message data together after being associated by the data manager.

Preferably, the first acquisition unit acquires the activity log data of the user activity of measuring a lesion in a diagnostic image formed by performing medical imaging of the patient body.

Preferably, assuming that plural lesions are found in the diagnostic image, the first acquisition unit acquires one set of the activity log data from activity log data of plural user activities of measuring the plural lesions.

Preferably, the record log screen includes a timeline screen area for displaying the activity log data and the message data in a time sequence.

Preferably, the data manager associates the activity log data and the message data in response to an association request input by a medical worker with the timeline screen area.

Preferably, the display output control unit displays the activity log data or the message data after being associated by the association request of the medical worker during access thereto in the group screen area in a distinct display form from the activity log data or the message data after being associated by the association request of a medical worker different from the medical worker during the access.

Preferably, the association request is constituted by an activity of drag and drop of the activity log data and the message data in the timeline screen area to the group screen area.

Preferably, the record log screen further includes an envelope screen area for indicating an envelope for grouping the activity log data and the message data by a unit of a group.

Preferably, the activity log data and the message data grouped in the envelope selected in the envelope screen area are displayed in the group screen area.

Preferably, the display output control unit performs removal of the envelope upon an input of the medical worker.

In another preferred embodiment, the display output control unit performs removal of the envelope according to a display period of displaying the envelope in the record log screen.

In still another preferred embodiment, the display output control unit performs removal of the envelope according to an attribute of the group.

Preferably, furthermore, a third acquisition unit acquires authorization data of authorization for access to the activity log data from the display terminal apparatus. The display output control unit performs display control of the activity log data according to the authorization data.

Preferably, furthermore, an acquisition unit acquires note data of note text of the medical worker for self-reporting from the medical user terminal apparatus. The display output control unit performs display control of the note data in the group screen area in addition to the activity log data and the message data.

Also, a non-transitory computer readable medium for storing a computer-executable program is provided, the computer-executable program enabling execution of computer instructions to perform operations for medical support. The operations include acquiring activity log data of a user activity related to a test result from a display terminal apparatus for displaying a test result of a diagnostic test performed to a patient body. The operations include acquiring message data of a message transmitted between medical user terminal apparatuses from the medical user terminal apparatuses used by medical workers. The operations include registering the activity log data and the message data to a storage medium in a manner associated with one another. The operations include performing display control of a record log screen having a group screen area for displaying the activity log data and the message data together after being associated.

Also, a medical support system is provided, including a medical support apparatus, a display terminal apparatus, connected to the medical support apparatus by use of a network, for displaying a test result of a diagnostic test to a patient body, and medical user terminal apparatuses, connected to the medical support apparatus by use of the network, and operated by a medical worker. The medical support apparatus includes a first acquisition unit for acquiring activity log data of a user activity related to the test result from the display terminal apparatus. A second acquisition unit acquires message data of a message transmitted between medical user terminal apparatuses from the medical user terminal apparatuses. A data manager registers the activity log data and the message data to a storage medium in a manner associated with one another. A display output control unit performs display control of a record log screen having a group screen area for displaying the activity log data and the message data together after being associated by the data manager.

Preferably, furthermore, an EMR terminal apparatus is connected with the network, for outputting a display screen of EMR data of an electronic medical record of a progress of the patient body. An image display terminal apparatus is connected with the network, for outputting an image screen of image data of a diagnostic image obtained by performing imaging of the patient body. The display output control unit outputs the record log screen to the image display terminal apparatus. The image display terminal apparatus outputs the record log screen to the second display panel in addition to the image screen.

Preferably, the display output control unit further outputs a combined screen of combined medical care data to the image display terminal apparatus by combining the EMR data and the image data. The image display terminal apparatus further outputs the combined screen to the second display panel.

Preferably, the combined screen is constituted by a graphical user interface for requesting display of the record log screen.

Consequently, a causal relationship between the information of the user activity and the messages can be recognized reliably, because a group screen area in a display screen can indicate the activity log data and message data in an associated form.

### BRIEF DESCRIPTION OF THE DRAWINGS

The above objects and advantages of the present invention will become more apparent from the following detailed description when read in connection with the accompanying drawings, in which:

FIG. 1 is a block diagram schematically illustrating a medical support system;

FIG. 2 is a block diagram schematically illustrating an EMR terminal apparatus and an EMR server apparatus and information transmitted between those;

FIG. 3 is a block diagram schematically illustrating a display terminal apparatus and an image server apparatus and information transmitted between those;

FIG. 4 is a block diagram schematically illustrating the display terminal apparatus and a medical support apparatus and information transmitted between those;

FIG. 5 is a data chart illustrating EMR data;

FIG. 6 is a data chart illustrating image data;

FIG. 7 is a block diagram schematically illustrating circuit devices in a computer for the medical support apparatus;

FIG. 8 is a block diagram schematically illustrating circuit devices in an image display terminal apparatus;

FIG. 9 is a block diagram schematically illustrating circuit devices in the medical support apparatus;

FIG. 10 is a screen view illustrating an activity log data table;

FIG. 11 is a screen view illustrating a message data table;

FIG. 12 is a screen view illustrating an envelope data table;

FIG. 13 is a screen view illustrating a combined screen of combined medical care data;

FIG. 14 is a screen view illustrating a viewer screen;

FIG. 15 is a screen view illustrating a menu tag for a record log;

FIG. 16 is a screen view illustrating a record log screen;

FIG. 17 is a screen view illustrating an envelope screen area;

FIG. 18 is a screen view illustrating an editing/removal dialog box;

FIG. 19 is a screen view illustrating a timeline screen area;

FIG. 20 is a screen view illustrating the timeline screen area after scroll;

FIG. 21 is a screen view illustrating a group screen area;

FIG. 22 is a screen view illustrating drag and drop of information to the group screen area;

FIG. 23 is a screen view illustrating the group screen area after association;

FIG. 24 is a flow chart illustrating steps of operation in the medical support apparatus;

FIG. 25 is a flow chart illustrating a second acquisition step;

FIG. 26 is a flow chart illustrating association of data;

FIG. 27 is a flow chart illustrating transmission of a delivery request;

FIG. 28 is a screen view illustrating an activity log data table of a second preferred embodiment;

FIG. 29 is a screen view illustrating a message data table;

FIG. 30 is a screen view illustrating a group screen area;

FIG. 31 is a explanatory view illustrating a third preferred embodiment in which an envelope is removed according to a display period;

FIG. 32 is a screen view illustrating an envelope data table in a fourth preferred embodiment;

FIG. 33 is a table illustrating time points of the removal;

FIG. 34 is a explanatory view illustrating the removal of the envelope;

FIG. 35 is a screen view illustrating an authorization dialog box;

FIG. 36 is a block diagram schematically illustrating a fifth preferred embodiment with circuit devices in a medical support apparatus;

FIG. 37 is a screen view illustrating an activity log data table;

FIG. 38 is a screen view illustrating a timeline screen area;

FIG. 39 is a block diagram schematically illustrating a sixth preferred embodiment with circuit devices in a medical support apparatus;

FIG. 40 is a screen view illustrating a note data table of note text;

FIG. 41 is a screen view illustrating a group screen area;

FIG. 42 is a screen view illustrating an annotation text for a diagnostic image.

### DETAILED DESCRIPTION OF THE PREFERRED EMBODIMENT(S) OF THE PRESENT INVENTION

### First Embodiment

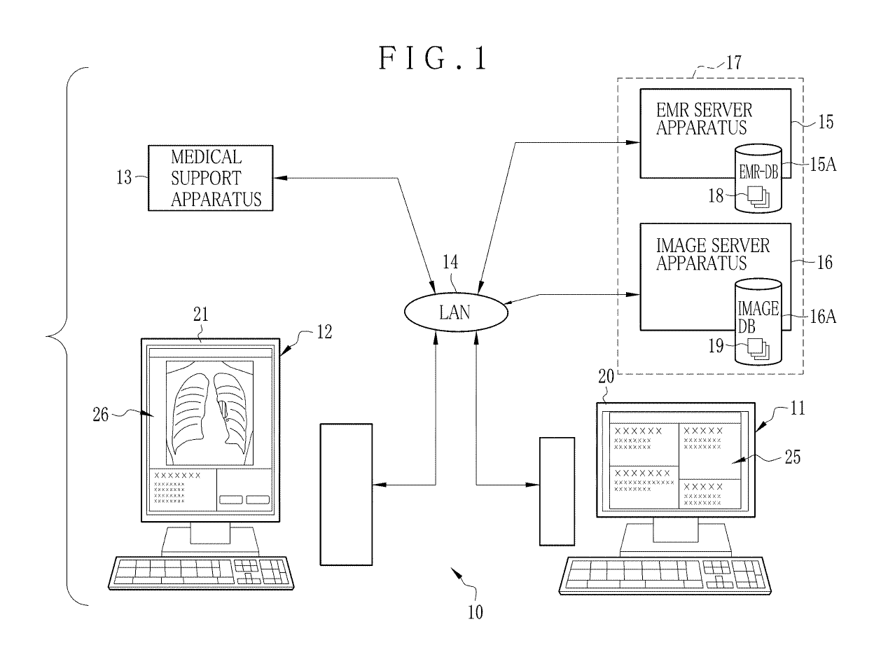

In FIG. 1, a medical support system 10 is established in a site of a medical facility (hospital facility), and includes an EMR terminal apparatus 11 or electronic medical record terminal apparatus, a display terminal apparatus 12, a medical support apparatus 13 or medical support server apparatus, and the like. A LAN 14 or local area network is installed in the medical facility, and interconnects the EMR terminal apparatus 11, the display terminal apparatus 12 and the medical support apparatus 13 in a communicable manner.

An EMR server apparatus 15 or electronic medical record server apparatus and an image server apparatus 16 are connected to the LAN 14, and are included in a server cluster 17. An EMR database 15A or electronic medical record database or EMR-DB is combined with the EMR server apparatus 15, and stores EMR data 18 or electronic medical record data of numerous EMRs (electronic medical records). An image database 16A is combined with the image server apparatus 16, and stores image data 19 of diagnostic images obtained by imaging of various modalities in a searchable manner.

Examples of various modalities of imaging include CR Imaging (Computed Radiography), CT imaging (Computed Tomography Imaging), MRI imaging (Magnetic Resonance Imaging), ECG test (electrocardiogram), CAG imaging (Coronary Angiography), US imaging (ultrasound imaging or ultrasonography), endoscopic imaging and the like. For example, the image data 19 of the CR, CT or MRI imaging are in a format according to the DICOM (Digital Imaging and Communications in Medicine).

In addition to the EMR server apparatus 15 and the image server apparatus 16, the server cluster 17 includes a report server apparatus with which a database stores medical reports containing results of image interpretation of the diagnostic images by a radiologist in a searchable manner. Also, the server cluster 17 may include a gene information server apparatus with which a database stores gene information of patients in a searchable manner.

Each of the EMR terminal apparatus 11, the display terminal apparatus 12, the medical support apparatus 13 and the server cluster 17 is constituted by a computer and programs installed in the computer. Examples of the computer are a personal computer, server computer, workstation and the like. Examples of the programs are control programs such as an operating system (OS), various applications and the like.

The EMR terminal apparatus 11 and the display terminal apparatus 12 are operated by medical workers, such as a doctor, nurse, medical technician for diagnostic tests, and the like. At least one pair of the EMR terminal apparatus 11 and the display terminal apparatus 12 is disposed for various medical workers and/or various hospital departments, such as an internal medicine, surgery, radiology, diagnostic tests, rehabilitation, and the like. The EMR terminal apparatus 11 and the display terminal apparatus 12 are used while various functions of the medical support apparatus 13 and the server cluster 17 are utilized for medical care of a patient.

The EMR terminal apparatus 11 and the display terminal apparatus 12 are arranged together on one desk or table, and used by one medical worker, such as a doctor. A first display panel 20 of the EMR terminal apparatus 11 has a horizontally long form. A second display panel 21 of the display terminal apparatus 12 has a vertically long form.

The medical support apparatus 13 combines and edits various medical care data acquired in the course of medical care for the purpose of supporting medical care of medical workers, specially, doctors. The medical care data include the EMR data 18 and the image data 19.

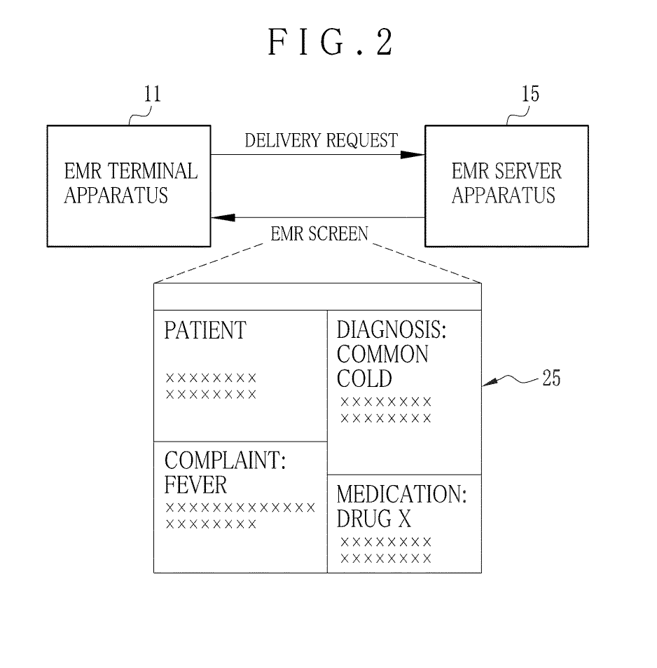

In FIG. 2, the EMR server apparatus 15 receives a delivery request for an EMR screen 25 or electronic medical record page or EMR display screen of the EMR data 18 from the EMR terminal apparatus 11. In response to the delivery request, the EMR server apparatus 15 acquires the EMR data 18 of a particular patient (patient body) for medical care from the EMR database 15A, and creates the EMR screen 25 according to the EMR data 18. The EMR server apparatus 15 transmits the EMR screen 25 to the EMR terminal apparatus 11 as a requester of the delivery request. The EMR terminal apparatus 11 outputs the EMR screen 25 from the EMR server apparatus 15 to the first display panel 20 in FIG. 1.

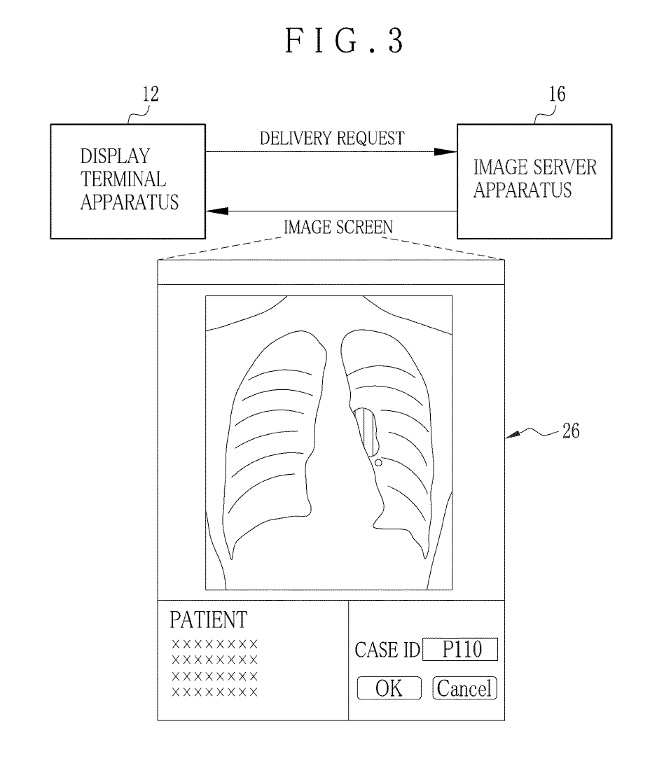

In FIG. 3, the image server apparatus 16 receives a delivery request for an image screen 26 or image display screen of the image data 19 from the display terminal apparatus 12. Also, the image server apparatus 16 acquires the image data 19 of the particular patient from the image database 16A according to the delivery request. The image server apparatus 16 creates the image screen 26 according to the medical care data, and delivers the image screen 26 to the display terminal apparatus 12 as a requester of the delivery request. The display terminal apparatus 12 outputs the image screen 26 from the image server apparatus 16 to the second display panel 21 in FIG. 1.

The imaging is included in the various diagnostic tests. The image data 19 are included in test results of the diagnostic tests. The display terminal apparatus 12 where the image screen 26 is displayed on the second display panel 21 corresponds to a display terminal apparatus for displaying test results of the diagnostic tests to the patient.

Also, a message is exchanged between the display terminal apparatuses 12, such as a reminder for image interpretation of a diagnostic image. The display terminal apparatuses 12 correspond to a medical user terminal apparatus for use by a medical worker to exchange messages.

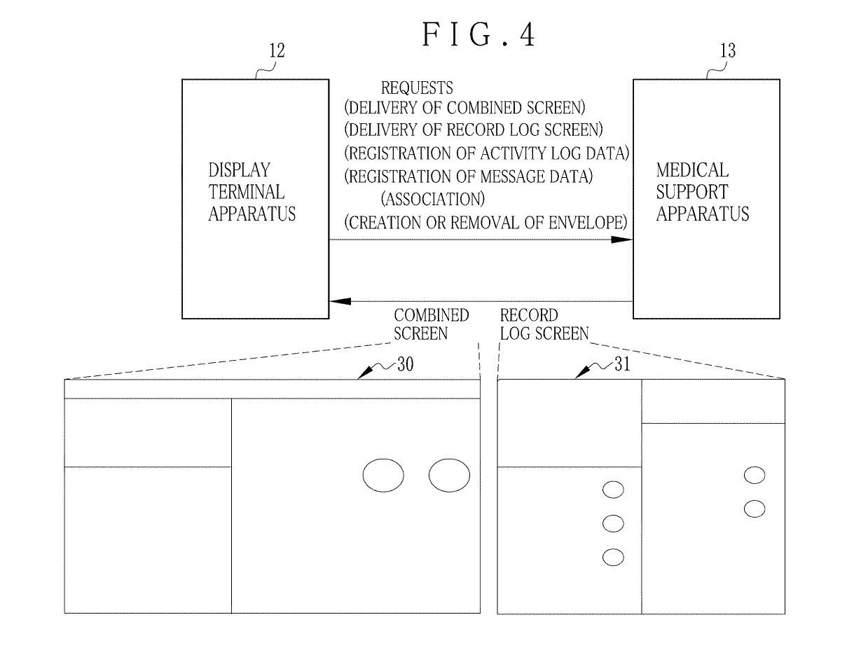

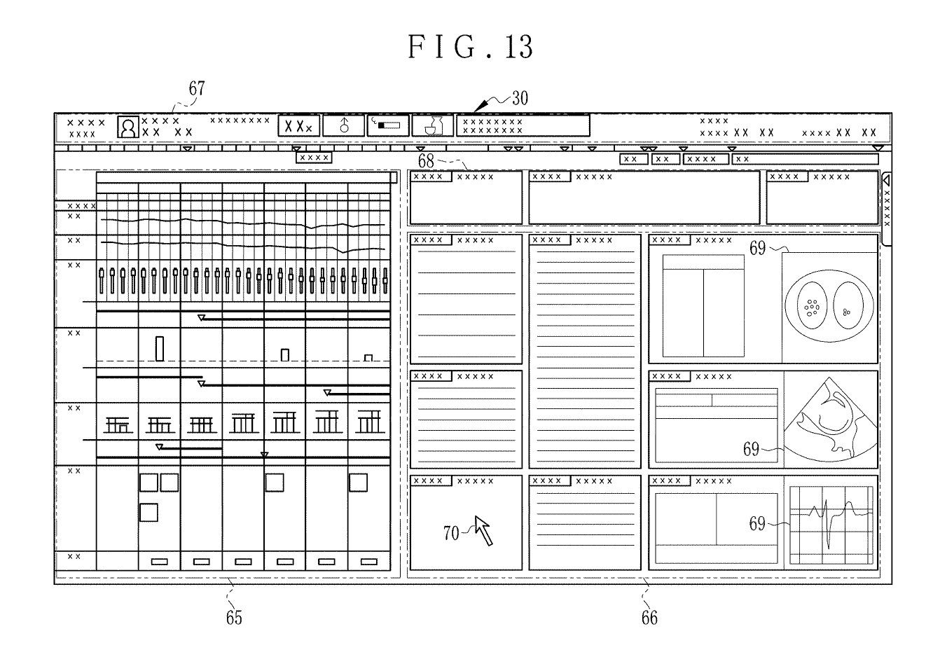

In FIG. 4, the medical support apparatus 13 receives various requests from the display terminal apparatus 12. Examples of the requests include a delivery request for a combined screen 30 or combined display screen of combined medical care data, namely, various medical care data of the patient including the EMR data 18 and the image data 19 (see FIG. 13), and a delivery request for a record log screen 31 or record log display screen. The combined screen 30 is a single information page for a doctor to review and analyze the medical care data of the patient. The record log screen 31 is an information page for displaying activity log data of user activities by a medical worker with the display terminal apparatus 12 in relation to the test results, and message data of messages transmitted between a plurality of the display terminal apparatuses 12.

The medical support apparatus 13 acquires the various medical care data of the particular patient from the server cluster 17 according to the delivery request for the combined screen 30. The medical support apparatus 13 creates the combined screen 30 according to the medical care data, and delivers the combined screen 30 to the display terminal apparatus 12 as a requester of the delivery request. The display terminal apparatus 12 outputs the combined screen 30 from the medical support apparatus 13 to the second display panel 21.

The medical support apparatus 13 creates the record log screen 31 according to the delivery request for the record log screen 31. The medical support apparatus 13 sends the record log screen 31 to the display terminal apparatus 12 as a requester of the delivery request. The display terminal apparatus 12 outputs the record log screen 31 from the medical support apparatus 13 to the second display panel 21.

Examples of requests received from the display terminal apparatus 12 to the medical support apparatus 13 include not only the delivery request for the combined screen 30 and the record log screen 31 but a registration request for activity log data, a registration request for message data, an association request for the activity log data and the message data, and a creation request or removal request for an envelope. The medical support apparatus 13 registers the activity log data in response to the registration request for the activity log data, and registers the message data in response to the registration request for the message data. Also, the medical support apparatus 13 associates the activity log data and the message data together in response to the association request for the activity log data and the message data. The medical support apparatus 13 creates or removes an envelope in response to the creation request or removal request for the envelope.

The envelope as a term used herein means a set of the activity log data and the message data in the unit of a group. The group is a team of plural medical workers who should share the activity log data and the message data for cooperation. Examples of the group include a group of an attending doctor (attending physician), an attending nurse (nurse leader) and their assistants with a purpose of team treatment for an in-patient, a group of trainee radiologists of internship and an attending doctor (professor) of radiology teaching those in a medical training workshop of the image interpretation, a group of trainee doctors and a highly experienced doctor giving advice thereto, and the like.

The medical support apparatus 13 creates the combined screen 30 and the record log screen 31 for display with the web browser, and delivers the combined screen 30 and the record log screen 31 to the display terminal apparatus 12. The medical support apparatus 13 issues an authorization key to the display terminal apparatus 12, and gives authorization for access to the medical support apparatus 13. After performing the authorization, the combined screen 30 and the record log screen 31 are displayed on the second display panel 21 of the display terminal apparatus 12 after reception from the medical support apparatus 13.

The medical support apparatus 13 outputs the combined screen 30 and the record log screen 31 in a format of XML data for web delivery created according to the XML (Extensible Markup Language) as a markup language. The display terminal apparatus 12 performs display processing (display control) to display the combined screen 30 and the record log screen 31 on the web browser according to the XML data. Also, it is possible to use another data description language instead of the XML, such as JSON (JavaScript Object Notation) and the like, JavaScript being a trade name. In a similar manner to the medical support apparatus 13, the EMR server apparatus 15 and the image server apparatus 16 output respectively the EMR screen 25 and the image screen 26 in a format of page data for web delivery.

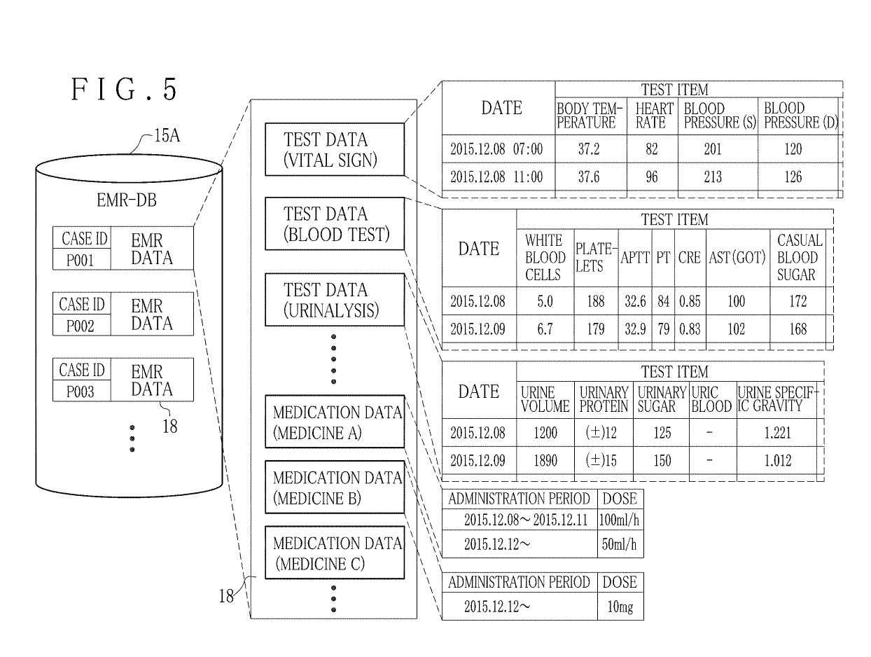

In FIG. 5, the EMR data 18 in the EMR database 15A are managed for the unit of the patient by association of a case ID (identification data), for example, P001, as signs and/or numbers for identifying each case or patient. The EMR data 18 in the EMR server apparatus 15 are searchable from the EMR database 15A by use of the case ID as a query.

The EMR data 18 have plural test data and plural medication data. The test data are data of test types of vital sign measurement, blood test, urinalysis and the like. Metadata are associated with the test data, including test items, test date/time information (date or time), and test values. Examples of the test items for the vital sign measurement are body temperature, heart rate, blood pressure (systolic and diastolic) and the like. Examples of the test items for the blood test are the number of white blood cells, platelets, casual blood sugar and the like. The medication data are data of pharmaceutical drug types (pharmaceutical drug names), such as pharmaceutical drugs A and B. Metadata are associated with the medication data, including a dose and administration period.

Various items of personal information are recorded in the EMR data 18, including the case ID, name, sex, age and birthday of the patient, preference of smoking and drinking, medical history, allergy and the like. Also, additional data are recorded in the EMR data 18 in a time sequential manner, including information of a request for a diagnostic test, creation of a medical report, surgery, medication and the like, and information of patient events in the course of medical care of the patient, such as a first patient visit, hospital admission, hospital discharge and the like, and information of chief complaint, progress note, record of nursing, additional record of information from the family of the patient, and the like.

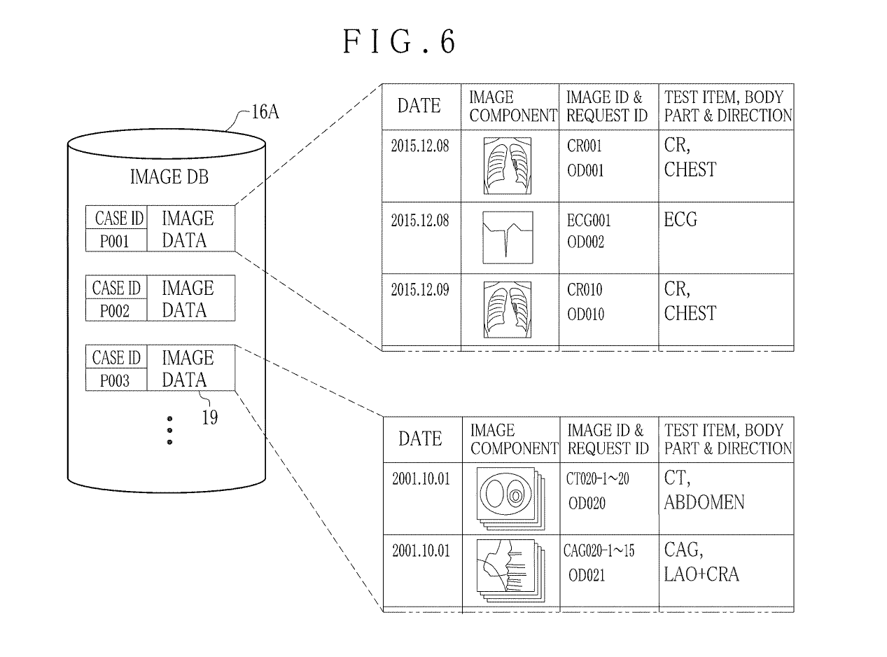

In FIG. 6, the image data 19 in the image database 16A are managed by the unit of the patients in association with the case IDs in the same manner as the EMR data 18. In the image server apparatus 16, the image data 19 are searchable from the image database 16A by use of a query of the case IDs, in the same manner as the EMR server apparatus 15.

A file of one set of the image data 19 is constituted by an image component of the image data 19 and meta information, which includes imaging date/time information, image ID, request ID, imaging modality, body part, imaging direction and the like. The image server apparatus 16 transmits the image data 19 to the medical support apparatus 13 as medical care data together with the meta information.

The image ID is signs and/or numbers for identifying each of the image data 19. The request ID is signs and/or numbers for identifying a request for instructing imaging of each of imaging methods. For the imaging methods to form a plurality of the image data 19 at one imaging session, such as the CT imaging and CAG imaging, one request ID is assigned to the image data 19 commonly to express one imaging session of forming the plurality of the image data 19, which can be handled as one set of the images.

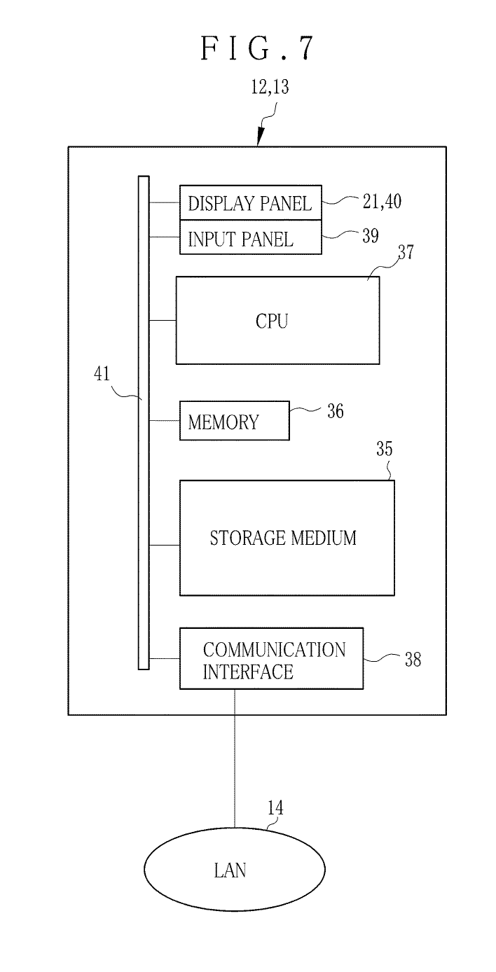

In FIG. 7, the display terminal apparatus 12 and the medical support apparatus 13 are constituted by computers of which structures are basically equal. Each computer has a storage medium 35 or storage device, a memory 36, a CPU 37 or central processing unit, a communication interface 38, and an input panel 39 or input device. The medical support apparatus 13 has a display panel 40 as well as the display terminal apparatus 12 has the second display panel 21. A data bus 41 interconnects those circuit devices.

The storage medium 35 is a hard disk drive incorporated in the computer constituting the display terminal apparatus 12 and the like, or connected to the computer by a cable, network or the like. Also, the storage medium 35 may be a disk array having plural hard disk drives. The storage medium 35 stores a control program and various application programs such as the Operating System (OS), and display screen data for control pages associated with the programs.

The memory 36 is a working memory with which the CPU 37 performs tasks. The CPU 37 loads the memory 36 with the programs stored in the storage medium 35, and controls the various circuit devices in the computer by performing the tasks according to the program.

The communication interface 38 is a network interface for control of transmission of various data by use of the LAN 14. The display panel 40 (or the second display panel 21) displays a control page where a user activity can be performed by use of the input panel 39, inclusive of a mouse, keyboard and the like. The control page has a function according to the GUI (graphical user interface). The computer constituting the display terminal apparatus 12 receives manual inputs from the input panel 39 by use of the various menus in the control page.

In the following description, a sign A will be added to each of reference signs of components in the computer constituting the display terminal apparatus 12 except for the second display panel 21. A sign B will be added to each of reference signs of components in the computer constituting the medical support apparatus 13 except for the display panel 40.

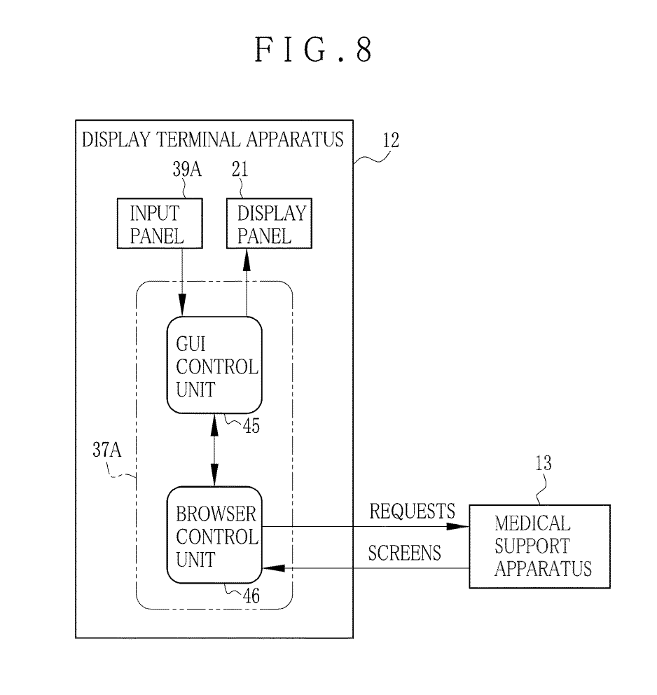

In FIG. 8, running the web browser causes a CPU 37A or central processing unit in the display terminal apparatus 12 to establish a GUI control unit 45 and a browser control unit 46 by cooperating with the memory 36 and the like.

The second display panel 21 is controlled by the GUI control unit 45 and displays various control pages. An input panel 39A or input device is operated to perform inputs of user activities to the GUI control unit 45 by use of a control pages. Examples of the user activities are a request for information delivery of the combined screen 30 and the record log screen 31 to the medical support apparatus 13, a registration request for activity log data, a registration request for message data, and an association request for the activity log data and message data. The GUI control unit 45 sends signals of the user activities to the browser control unit 46.

The browser control unit 46 controls operation of the web browser. The browser control unit 46 sends requests to the medical support apparatus 13 according to command signals from the GUI control unit 45, the requests including a delivery request according to a command signal for delivery, a registration request according to a command signal for registration, and an association request according to a command signal for association.

The browser control unit 46 receives (downloads) image data of the combined screen 30 and the record log screen 31 from the medical support apparatus 13. The browser control unit 46 forms the combined screen 30 and the record log screen 31 according to the image data in a manner for display on the web browser, and sends the combined screen 30 and the record log screen 31 to the GUI control unit 45. The GUI control unit 45 drives the second display panel 21 to display the combined screen 30 and the record log screen 31.

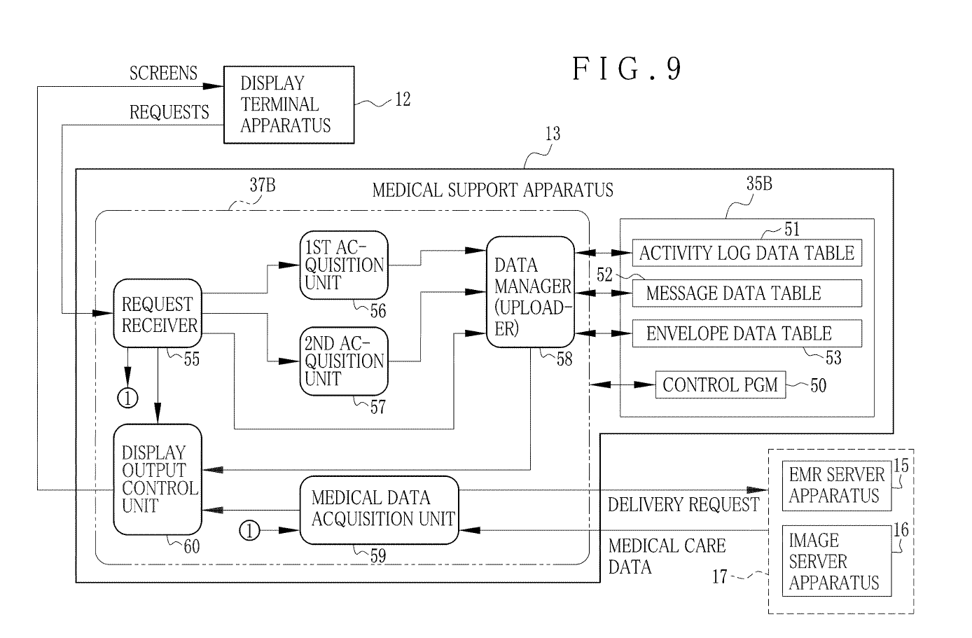

In FIG. 9, a control program 50 (computer-executable program) is stored in a storage medium 35B or storage device in the medical support apparatus 13. The control program 50 is an application program to cause a computer constituting the medical support apparatus 13 to function as a medical support apparatus.

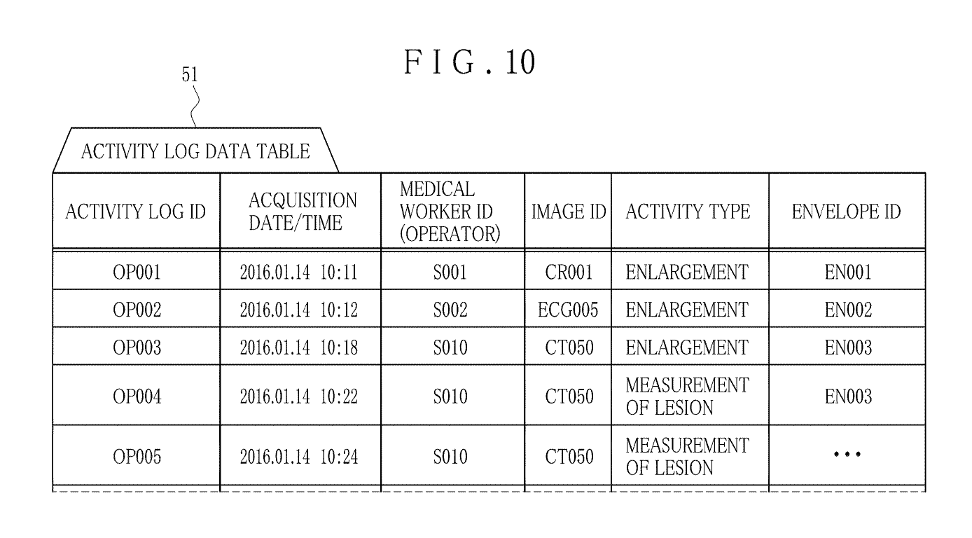

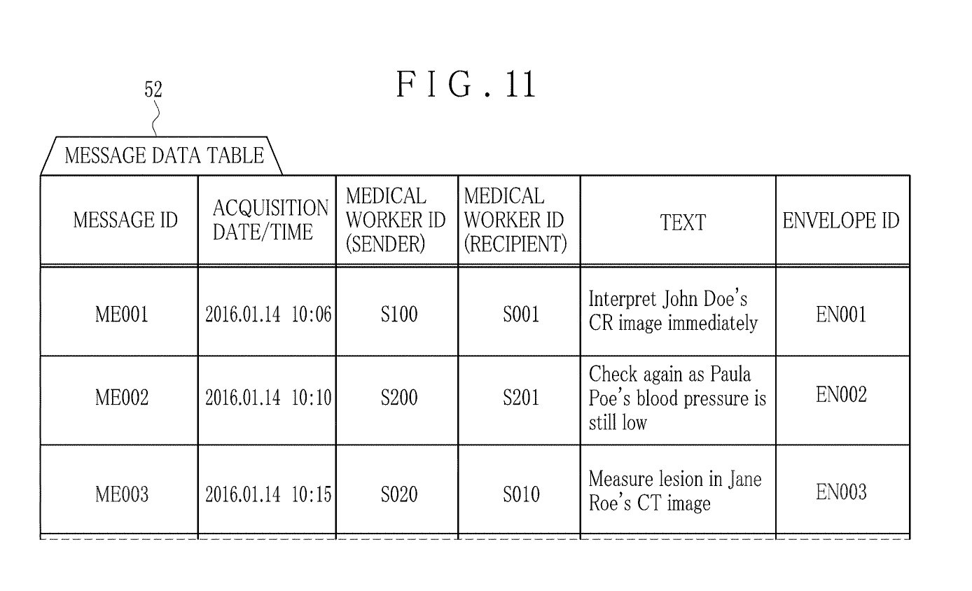

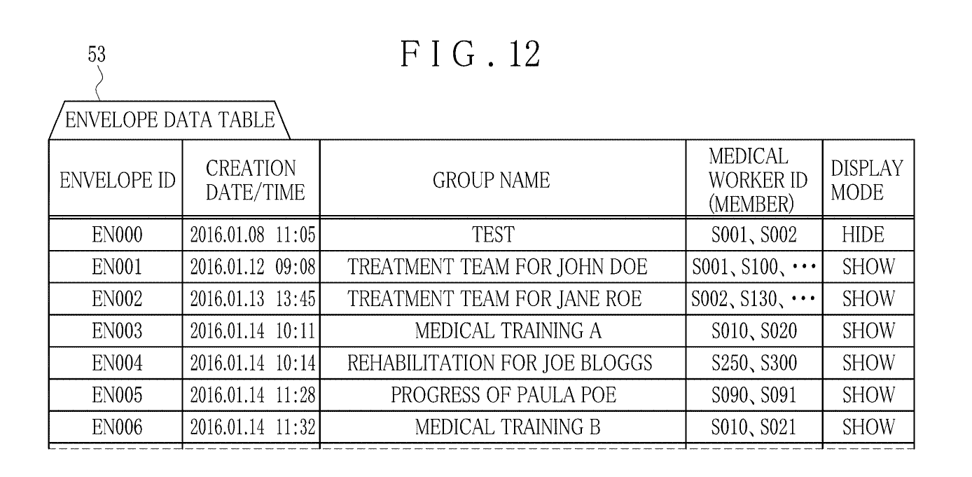

The storage medium 35B stores an activity log data table 51, a message data table 52, and an envelope data table 53 or messaging group data table, which are required for creating the record log screen 31 in addition to the control program 50. Activity log data is registered in the activity log data table 51 in FIG. 10. Message data is registered in the message data table 52 in FIG. 11. Envelope data of an envelope is registered in the envelope data table 53 in FIG. 12.

In case the control program 50 is run, a CPU 37B or central processing unit in the medical support apparatus 13 cooperates with the memory 36, so that a request receiver 55, a first acquisition unit 56, a second acquisition unit 57, a data manager 58 or uploader, a medical data acquisition unit 59, a display output control unit 60 or display processor or page generator, are established.

The request receiver 55 receives various requests from the display terminal apparatus 12. The request receiver 55 sends a delivery request for the combined screen 30 to the medical data acquisition unit 59 and the display output control unit 60, sends a delivery request for the record log screen 31 to the data manager 58 and the display output control unit 60, sends a registration request for the activity log data to the first acquisition unit 56, sends a registration request for the message data to the second acquisition unit 57, sends an association request for the activity log data and message data to the data manager 58, and sends a creation request or removal request for the envelope to the data manager 58.

The first acquisition unit 56 performs first acquisition of acquiring activity log data included in a registration request for the activity log data from the request receiver 55. The first acquisition unit 56 sends the acquired activity log data to the data manager 58.

The second acquisition unit 57 performs second acquisition of acquiring message data included in a registration request for the message data from the request receiver 55. The second acquisition unit 57 sends the acquired message data to the data manager 58.

The data manager 58 performs data management of managing the activity log data, message data and envelope data. The data manager 58 registers the activity log data from the first acquisition unit 56 to the activity log data table 51, and registers the message data from the second acquisition unit 57 to the message data table 52. Also, the data manager 58 receives an association request from the request receiver 55, and associates the activity log data with the message data. Furthermore, the data manager 58 updates the envelope data in the envelope data table 53 according to a request for creating or removing the envelope according to the request receiver 55.

In response to the delivery request for the record log screen 31, the data manager 58 reads out the activity log data, message data and envelope data from the activity log data table 51, the message data table 52 and the envelope data table 53 as requirements for creating the record log screen 31. The data manager 58 sends the activity log data, message data and envelope data to the display output control unit 60.

The medical data acquisition unit 59 generates an acquisition request to the server cluster 17 in response to the delivery request for the combined screen 30. The server cluster 17 in response to the acquisition request transmits various medical care data of the particular patient to the medical data acquisition unit 59. The medical data acquisition unit 59 sets the acquired medical care data to the display output control unit 60.

The display output control unit 60 creates the combined screen 30 according to the various medical care data. The display output control unit 60 delivers the combined screen 30 to the display terminal apparatus 12 as a requester of the delivery request.

Also, the display output control unit 60 creates the record log screen 31 according to the activity log data, message data and envelope data. The display output control unit 60 delivers the record log screen 31 to the display terminal apparatus 12 as a requester of the delivery request. In short, the display output control unit 60 performs control of outputting the record log screen 31.

In FIG. 10, the activity log data table 51 has list items of an activity log ID, acquisition date/time information, operator medical worker ID (operator user), image ID, activity type (process) and envelope ID.

The activity log ID has signs and/or numbers for identifying an activity log of each user activity. The activity log ID is automatically allocated by the data manager 58 upon registering the activity log data. Date/time information of acquiring the activity log data in the first acquisition unit 56 is registered in the list item of the acquisition date/time information. The medical worker ID has signs and/or numbers for identifying a medical worker. The medical worker ID having performed the user activity is registered in the list item of the medical worker ID. The image ID of the image data 19 of which the medical care has been performed is registered in the list item of the image ID.

In the list item of the activity type (process), a specific activity type of the user activity is registered. For example, “Display in enlargement” is registered for activity log data of the activity log ID of OP001 as a user activity of enlarging and displaying the diagnostic image. “Measurement of lesion” is registered for activity log data of the activity log ID of OP004 as a user activity of measuring a lesion in the diagnostic image.

The envelope ID is signs and/or numbers for identifying each of the envelopes (messaging groups). The envelope ID of the envelope containing the particular activity log data which has been associated by the data manager 58 is registered in a list item of the envelope ID. In contrast, no envelope ID, in relation to the activity log data without being associated by the data manager 58, is registered in a list item of the envelope ID, for example, activity log data of the activity log ID of OP005. Note that the registration request for the activity log data includes the operator medical worker ID (operator user), image ID and activity type among the list items in the activity log data table 51.

In FIG. 11, the message data table 52 has list items of a message ID, acquisition date/time information, sender medical worker ID (sender user), recipient medical worker ID (recipient user), text (contents) and envelope ID.

The message ID is signs and/or numbers for identifying each of the messages. The message ID is automatically added by the data manager 58 upon registering the message data in the similar manner to the activity log ID. In the list item of the acquisition date/time information, the date/time information of acquisition of the message data in the second acquisition unit 57 is registered. In the list item of the sender medical worker ID (sender user), the medical worker ID of the medical worker as a sender of the message is registered. In the list item of the recipient medical worker ID (recipient user), the medical worker ID of the medical worker as a recipient of the message is registered.

The text of the message is registered for a list item of the text. For example, the message data of the message ID of ME001 includes the text of “Interpret John Doe's CR image immediately”, for a reminder of the image interpretation of the CR imaging. The message data of the message ID of ME003 includes the text of “Measure lesion in Jane Roe's CT image”, to instruct trainee radiologists to perform the measurement according to the attending doctor (professor) of radiology.

In the list item of the envelope ID, the envelope ID of the envelope containing the particular message data is registered after having been associated in the data manager 58 in a manner similar to the activity log data table 51. No envelope ID is registered in relation to the message data without being associated. The registration request for the message data includes the sender medical worker ID (sender user), the recipient medical worker ID (recipient user) and text among the list items in the message data table 52.

The envelope ID is included in the association request for the activity log data and message data. The data manager 58 registers the envelope ID in the association request to the list item of the envelope ID of the activity log data table 51 or the message data table 52. In short, the data manager 58 associates the activity log data with the message data by use of the envelope ID.

The activity log data and the message data of which the same envelope ID is registered are data shared in the group corresponding to the envelope of the envelope ID. For example, the same envelope ID of E003 is registered in association with the activity log data of the activity log IDs of OP003 and OP004 and the message data of the message ID of ME003. The activity log data and the message data are data shared in the group corresponding to the envelope of the envelope ID of E003.

In FIG. 12, examples of list items in the envelope data table 53 are an envelope ID, creating date/time information, group name, member medical worker ID (member user) and display mode.

The envelope ID is automatically allocated at the time of creating an envelope in the manner similar to the activity log ID and the message ID. Date/time information of receiving the creating request for an envelope from the request receiver 55 to the data manager 58 is registered in a list item of the date/time information. A name of a group corresponding to the envelope is registered in a list item of the group name. A medical worker ID of a medical worker of the group corresponding to the envelope is registered in a list item of the member medical worker ID (member user).

The display mode is information as to whether the envelope is displayed on the record log screen 31 or not. Assuming that the data manager 58 has not received a removal request from the request receiver 55, “Show” is registered in the list item of the display mode. Assuming that the data manager 58 has received the removal request from the request receiver 55, “Hide” is registered in the list item of the display mode. Note that the envelope data of which “Hide” is registered in the list item of the display mode is also maintained in the envelope data table 53. It is possible to redisplay the envelope on the record log screen 31 even with the display form of “Hide”, because the display form can be changed to “Show”.

The doctor performs access to the medical support apparatus 13 through the display terminal apparatus 12, and performs a step for receiving authorization by inputting his or her medical worker ID and an authorization key. The medical worker ID is combined with a registration request for the activity log data, and registered in the list item of the operator medical worker ID (operator user) in the activity log data table 51. Also, the medical worker ID is combined with a registration request for the message data, and registered in the list item of the recipient medical worker ID (recipient user) in the message data table 52.

An input page for the case ID is caused to appear on the second display panel 21 of the display terminal apparatus 12 with the web browser after performing the authorization. The input page for the case ID includes an input box for the case ID and a send button for sending a delivery request for the combined screen 30. In case the case ID of the patient is input and the send button is selected (pressed), then the browser control unit 46 of the display terminal apparatus 12 sends a delivery request for the combined screen 30 to the request receiver 55, inclusive of the case ID of the patient.

An acquisition request from the medical data acquisition unit 59 to the server cluster 17 in response to the delivery request for the combined screen 30 is assigned with a search query of the case ID of the patient included in the delivery request for the combined screen 30. The server cluster 17 sends medical care data to the medical data acquisition unit 59, inclusive of the EMR data 18 and the image data 19 with the case ID of the patient. The display output control unit 60 creates the combined screen 30 of FIG. 13 according to the medical care data of the patient from the server cluster 17.

In FIG. 13, the combined screen 30 includes a first window 65 or test window, a second window 66 or diagnosis window, a third window 67 or personal window, and a fourth window 68 or comment window (or display areas). The first window 65 indicates graphs of test values and bars of medication, the test values being displayed in a time sequence for vital sign measurement of the body temperature, heart rate, blood pressure (systolic and diastolic) and the like, the bars representing doses and administration periods of pharmaceutical drugs.

The second window 66 has plural window regions for displaying medical care data. For example, a blood window region indicates test values of plural test items of the blood test in a list form. A urinalysis window region indicates test values of plural test items of the urinalysis. Also, a drug window region indicates types and doses of pharmaceutical drugs in a list form. Three window regions are disposed in a right side of the second window 66. A thumbnail image 69 of each of the diagnosis images is displayed in respectively the three window regions.

The third window 67 indicates personal information and doctor information, the personal information including a case ID, name, sex, age, birthday, preference, medical history, allergy and the like of the patient, the doctor information including a hospital department and a name of the doctor of the patient. The fourth window 68 has smaller sub windows for indicating chief complaint of the patient, progress note, record of nursing, information from his or her family and the like, which are described in description in the EMR data 18.

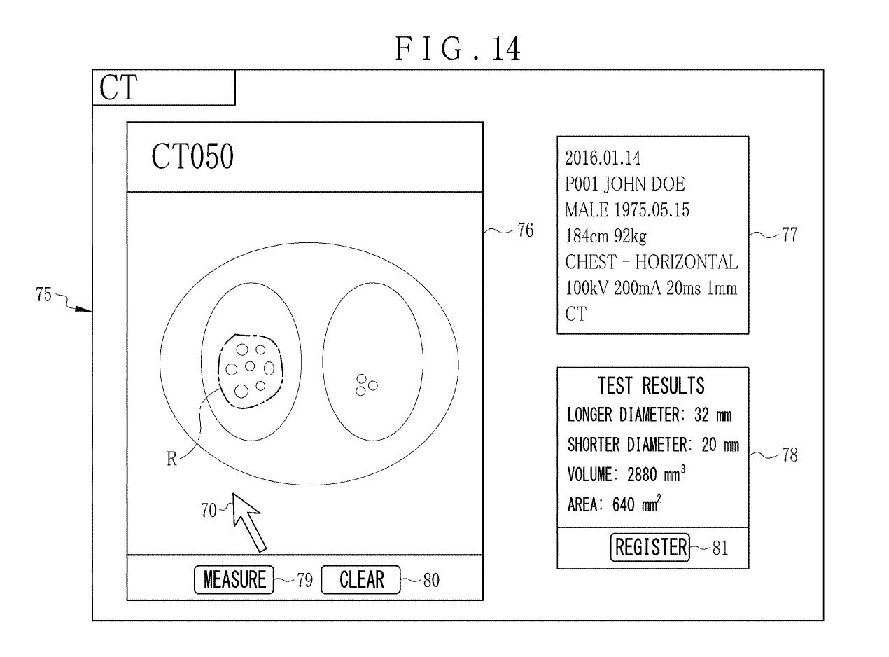

A cursor 70 is used to select (press) the thumbnail image 69 of the diagnostic image in the second window 66. Selecting the thumbnail image 69 with the cursor 70 causes a viewer screen 75 of FIG. 14 to appear in a popup form on the combined screen 30.

In FIG. 14, the viewer screen 75 includes an image window 76, a list item window 77 and a value window 78 or display areas. The image window 76 indicates a diagnostic image of a full size. The list item window 77 indicates the personal information such as the case ID and name of the patient, and meta information such as imaging date/time information, body part and imaging direction. The list item window 77 indicates test results of test values, such as longer and shorter diameters of a lesion in the diagnostic image. A measure button 79 and a clear button 80 are disposed in a lower portion of the image window 76. A register button 81 is disposed in a lower portion of the value window 78.

It is possible with the viewer screen 75 to view a diagnostic image of a full size in the image window 76 and measure a lesion in the diagnostic image. To measure the lesion, plural control points are designated around a periphery of an area with the cursor 70 for a potential lesion in the diagnostic image in the image window 76. In case a curve is drawn to pass the plural control points, then a portion defined by the curve or frame line of the phantom line is designated as an area R of the lesion. The area R is correctable freely by use of the cursor 70 assuming that a user wishes the correction. Also, designation of the area R can be cleared by selecting the clear button 80 with the cursor 70.

After the area R is designated, the measure button 79 is selected (pressed) with the cursor 70, to measure various values in the area R in the medical support apparatus 13. In FIG. 14, the value window 78 indicates results of the measurement. In case the register button 81 is selected with the cursor 70 while the value window 78 indicates the results, the location information of the area R, the results of the measurement and the image ID are associated together, and are registered in the storage medium 35B of the medical support apparatus 13.

In case the thumbnail image 69 is selected (pressed) with the cursor 70 in the combined screen 30, the browser control unit 46 sends a registration request for activity log data to the request receiver 55. In short, the selection of the thumbnail image 69 corresponds to a registration request for activity log data. Then the data manager 58 registers “Enlargement” in a list item of the activity type in the activity log data table 51.

Also, in case the measure button 79 in the viewer screen 75 is selected with the cursor 70, the browser control unit 46 sends a registration request for the activity log data to the request receiver 55. In short, the selection of the measure button 79 corresponds to the registration request for the activity log data. The data manager 58 is caused to register “Measurement of lesion” to the list item of the activity type in the activity log data table 51. Also, it is possible to generate a registration request for the activity log data upon selecting the register button 81 with the cursor 70 in place of the measure button 79.

In case a plurality of lesions are found in the diagnostic image, measurement of test values of the lesions is performed, namely, the area R for each lesion is designated and the measure button 79 is selected. At each time that the measure button 79 is selected for the lesions, the browser control unit 46 sends a registration request for the activity log data to the request receiver 55.

Assuming that a plurality of lesions are found in the diagnostic image, the first acquisition unit 56 acquires plural data of plural user activities for measuring the plural lesions as a single set of activity log data. For example, the activity log data with the activity log IDs of OP004 and OP005 in FIG. 10 are data of two user activities of measuring two lesions in the diagnostic image with the image ID of CT050 according to a medical worker with the medical worker ID of S010.

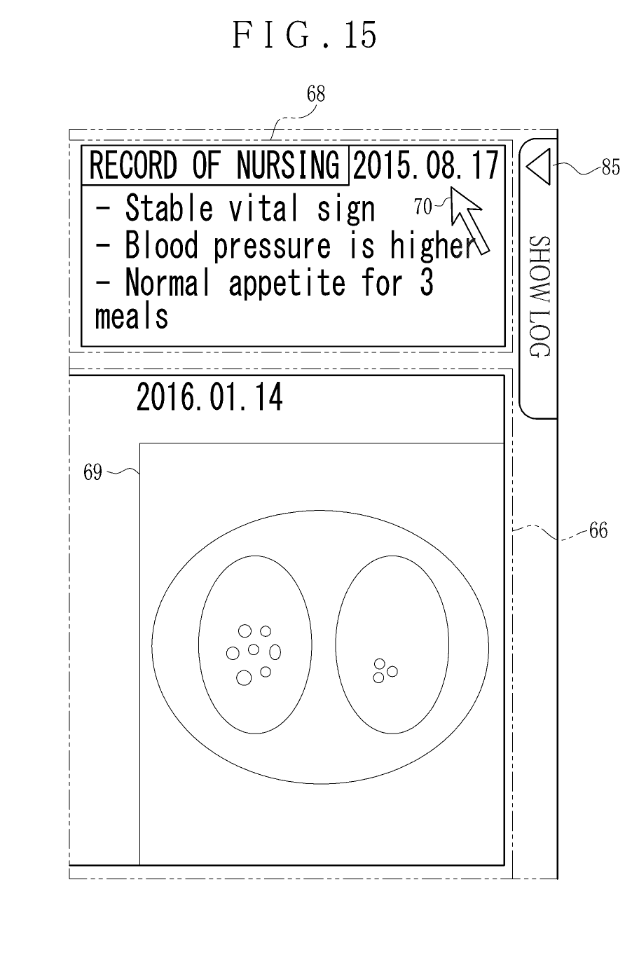

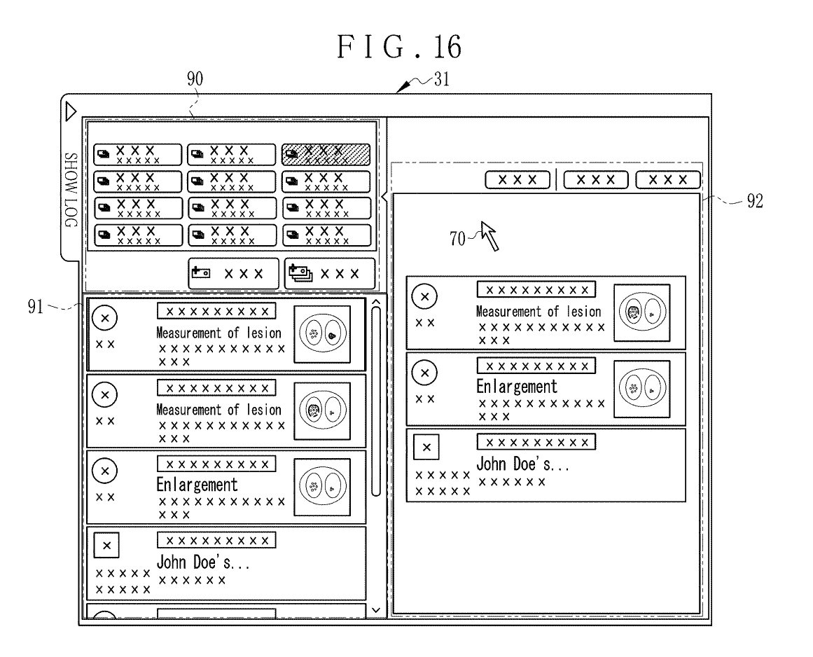

In FIG. 15, a menu tag 85 (menu tab) for a record log is disposed in the combined screen 30 on a right side of the second window 66 and the fourth window 68. In case the cursor 70 is positioned at the menu tag 85, the browser control unit 46 sends a delivery request for the record log screen 31 to the request receiver 55, to cause the record log screen 31 to appear on the combined screen 30 in FIG. 16. In short, the selection of the menu tag 85 corresponds to the delivery request for the record log screen 31. The menu tag 85 corresponds to the GUI for requesting the display of the record log screen 31.

In FIG. 16, the record log screen 31 has an envelope screen area 90 or group list screen area, a timeline screen area 91 and a group screen area 92. The envelope screen area 90 indicates information according to registered contents of the envelope data table 53. The timeline screen area 91 and the group screen area 92 indicate information according to registered contents of the activity log data table 51 and the message data table 52.

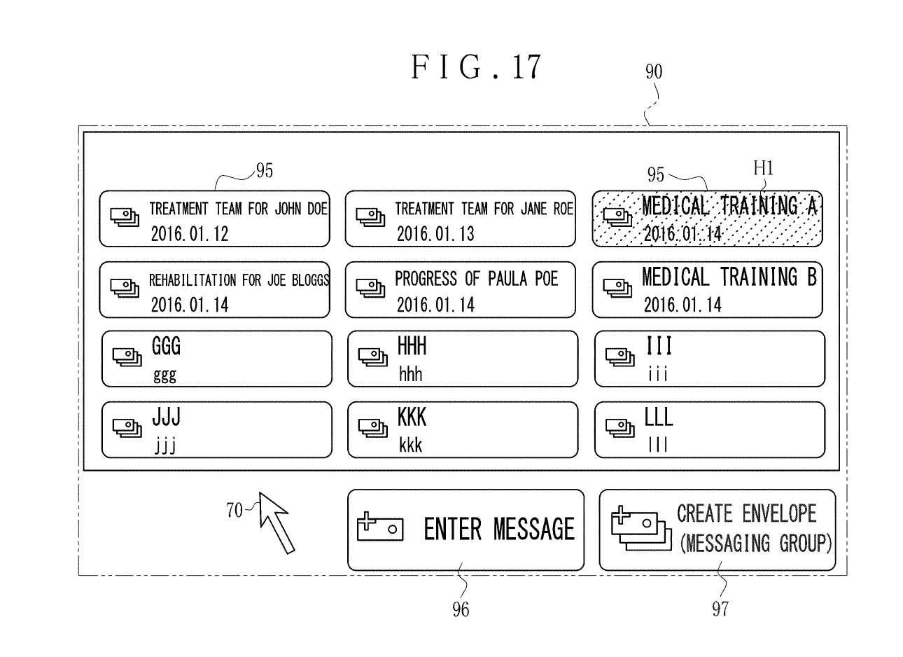

In FIG. 17, an envelope display block 95 (or envelope box) or EN block or messaging group display block is indicated in the envelope screen area 90 in a list form, the envelope display block 95 being registered in the envelope data table 53 with a registered list item for “Show” in the display mode. The envelope of which the envelope display block 95 is indicated in the envelope screen area 90 is an envelope of which the medical worker ID of the medical worker during the access to the medical support apparatus 13 is registered in the list item of the member medical worker ID (member). Also, an enter button 96 for a message and a create button 97 for an envelope or messaging group are disposed in a lower portion of the envelope screen area 90.

A group name and a creation date are indicated in the envelope display block 95. The envelope display block 95 is selectable with the cursor 70. The envelope display block 95 selected by the cursor 70 is displayed in a distinct display form from the other envelope display block 95 as indicated by a hatched portion H1 (highlighted portion), for example, in a different color. In FIG. 17, a condition of selecting the envelope display block 95 with the group name of “Medical training A on image interpretation” is illustrated at the envelope ID of EN003 of FIG. 12.

Selecting the enter button 96 with the cursor 70 causes an input page for messages to appear in the record log screen 31. The input page includes an input box for a recipient medical worker ID (recipient user), an input box for inputting text, and a send button for sending a registration request for the message data. In case the recipient medical worker ID (recipient user) and text are input in the input boxes and in case the send button is selected, then the browser control unit 46 sends the registration request for the message data to the request receiver 55.

Selecting the create button 97 with the cursor 70 causes a creation page for envelopes to appear in the record log screen 31. The creation page includes an input box for a group name, an input box for a member medical worker ID (member user), and a send button for sending a creation request for the envelope. In case the group name and the member medical worker ID (member user) are input in the input boxes and in case the send button is selected, then the browser control unit 46 sends the creation request for the envelope to the request receiver 55.

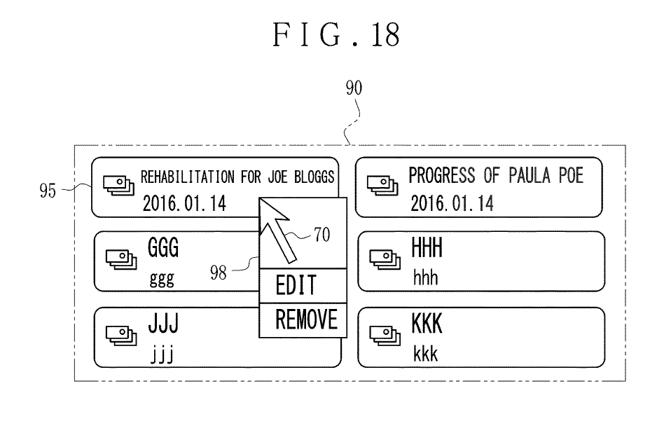

In case a right-side mouse button of a mouse is clicked by positioning the cursor 70 at the envelope display block 95 in FIG. 18, an editing/removal dialog box 98 is displayed in a popup form. An option of EDIT in the editing/removal dialog box 98 is selected by the cursor 70 to enable editing the envelope. Also, an option of REMOVE in the editing/removal dialog box 98 is selected by the cursor 70, so that a request for removal is sent by the browser control unit 46 to the request receiver 55. The activity of selecting the option of REMOVE in the editing/removal dialog box 98 with the cursor 70 corresponds to a user input of the medical worker.

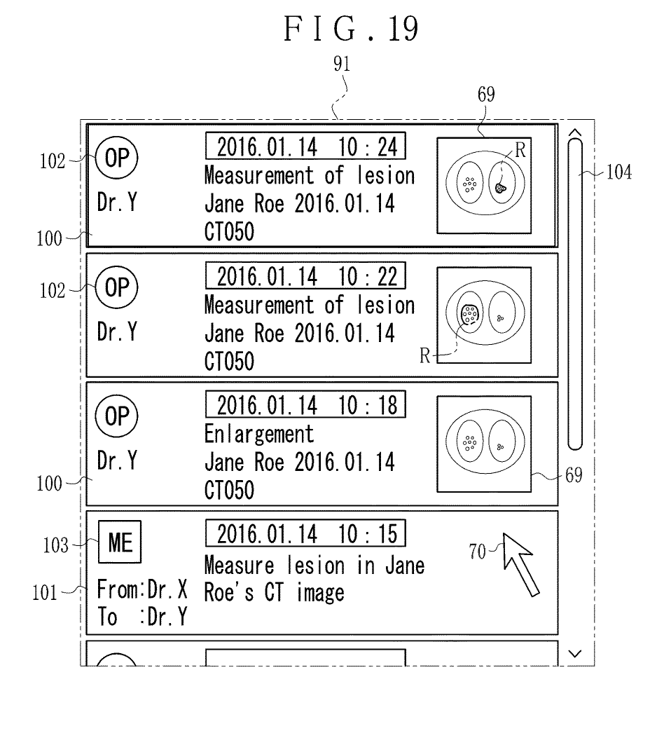

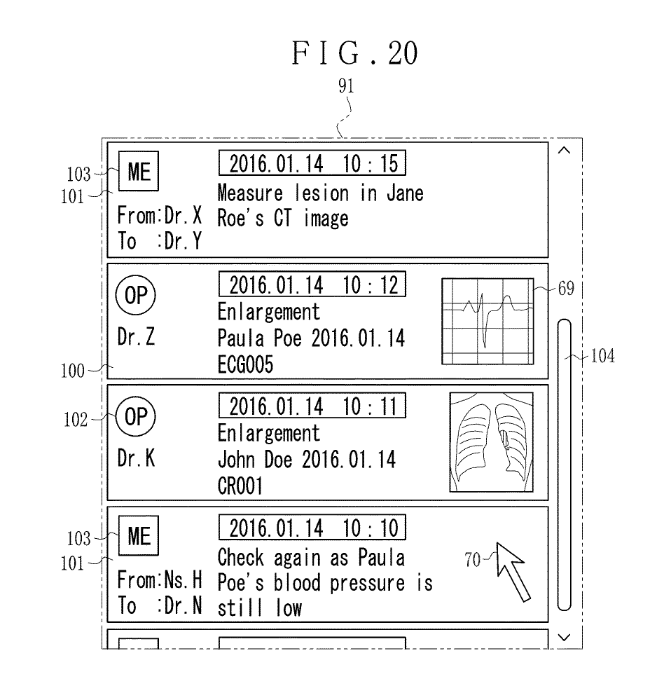

In FIGS. 19 and 20, an activity display block 100 (or activity screen view) or OP block and a message display block 101 (or message screen view) or ME block are indicated in the timeline screen area 91. The activity display block 100 contains activity log data registered in the activity log data table 51. The message display block 101 contains message data registered in the message data table 52. The message display block 101 is indicated in a color different from that of the activity display block 100. A letter code 102 or mark of OP is indicated in the activity display block 100 with a circle around the letters. A letter code 103 or mark of ME is indicated in the message display block 101 with a square around the letters. The activity display block 100 and the message display block 101 can be easily recognized with clarification owing to the two distinct colors and the presence of the letter codes 102 and 103.

Various data are displayed in the activity display block 100, including a name of a medical worker (Dr. Y, Dr. Z and the like), date/time information of the acquisition, activity log, image ID, the thumbnail image 69 of a diagnostic image, and the like, the medical worker having a medical worker ID registered in a list item of the operator medical worker ID (operator user) in the activity log data table 51. Assuming that the activity log is measurement of a lesion, then an area R of the lesion is indicated in the thumbnail image 69. It is possible to understand the name of the medical workers and the activity type of the activities only by simply viewing the information in the activity display block 100.

Various data are displayed in the message display block 101, including a name of a first medical worker (Dr. X, Nurse H and the like), a name of a second medical worker (Dr. Y, Dr. N and the like), date/time information of the acquisition, text of the message, and the like, the first medical worker having a medical worker ID registered in a list item of the sender medical worker ID (sender user) in the message data table 52, the second medical worker having a medical worker ID registered in a list item of the recipient medical worker ID (recipient user) in the message data table 52. It is possible to understand the names of the medical workers and the text of the messages only by simply viewing the information in the message display block 101.

The activity display block 100 and the message display block 101 are indicated in a time sequence, namely, in a sequence of the date/time information of acquiring the activity log data and message data. An uppermost disposed screen view in the timeline screen area 91 among the activity display block 100 and the message display block 101 is the activity display block 100 of the newest form or the message display block 101 of the newest form.

The timeline screen area 91 is updated at each time that the data manager 58 registers new activity log data or new message data to the activity log data table 51 or the message data table 52. Specifically, the activity display block 100 and the message display block 101 having been indicated in the timeline screen area 91 are shifted down by one row upon registering new activity log data or new message data. Newest information of the activity display block 100 or the message display block 101 becomes indicated in an uppermost row in the timeline screen area 91 by utilizing a blank space created by the shift of the row.

In FIG. 19, the activity display block 100 of the activity log data for the activity type of “Measurement of lesion” with the activity log ID of OP005 in FIG. 10 is disposed in an uppermost row in the timeline screen area 91.

The activity log data of the “Measurement of lesion” with the activity log ID of OP005 is activity log data without completing the association in the data manager 58. However, the activity display block 100 and the message display block 101 except for the activity display block 100 of the activity log data are related to the activity log data or message data after the association in the data manager 58. Accordingly, the timeline screen area 91 displays mixed information which includes the activity display block 100 of the activity log data or the message display block 101 of the message data after the association in the data manager 58, and the activity display block 100 of the activity log data or the message display block 101 of the message data before completing the association in the data manager 58. It is impossible clearly to recognize which of the activity log data and message data are associated only by viewing the timeline screen area 91. Note that the activity display block 100 of the activity log data or the message display block 101 of the message data before completing the association in the data manager 58 is displayed in a distinct display form from other objects, for example, is surrounded by a frame line with high thickness.

In case the activity display block 100 and the message display block 101 of a high number cannot be contained in the display screen at one time, a vertical scroll bar 104 is displayed with the timeline screen area 91. The cursor 70 is used to operate the vertical scroll bar 104 to scroll the timeline screen area 91 vertically.

In FIG. 20, a display form of the timeline screen area 91 is illustrated in a condition after shifting down the vertical scroll bar 104 from the display form of FIG. 19. The activity display block 100 and the message display block 101 with date/time information on or before the date/time of “2016.01.14, 10:15” are displayed in FIG. 20 although hidden in FIG. 19.

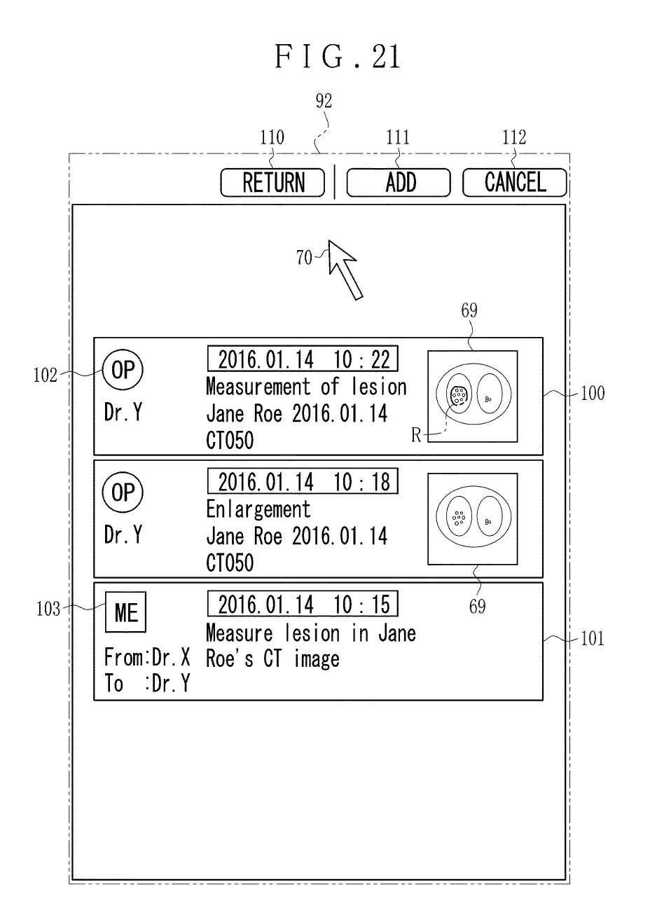

In FIG. 21, the group screen area 92 indicates the activity log data and the message data in the envelope of the envelope display block 95 selected by use of the envelope screen area 90 (group list screen area), namely the activity display block 100 of the activity log data and the message display block 101 of the message data associated together by the data manager 58 in combination with the envelope ID. A return button 110 (remove button), an add button 111 (association) and a cancel button 112 are disposed in an upper portion of the group screen area 92.

In the group screen area 92, the activity display block 100 and the message display block 101 are displayed in the sequence of the acquisition date/time information in the same manner as the timeline screen area 91. In FIG. 21, the envelope display block 95 of the group name of “Medical training A on image interpretation” is selected, which is indicated at the envelope ID of EN003 in FIG. 17. The activity display block 100 of the activity log data of the activity log IDs of OP003 and OP004 and the message display block 101 of the message data of the message ID of ME003 are indicated together in the time sequence, in the associated manner by the envelope ID of E003. The use of the group screen area 92 clarifies which of the activity log data and message area are associated with one another although it has not been clarified in the timeline screen area 91.

The message display block 101 and the message display block 101 in the group screen area 92 are selectable by use of the cursor 70. In case the return button 110 (remove button) is selected (pressed) after selecting the activity display block 100 or the message display block 101 in the group screen area 92, the selected one of the activity display block 100 and the message display block 101 is removed. The data manager 58 sets a blank in the list item of the envelope ID in the activity log data table 51 and the message data table 52 for the data in the activity display block 100 or the message display block 101 being removed, for return to a state before the association.

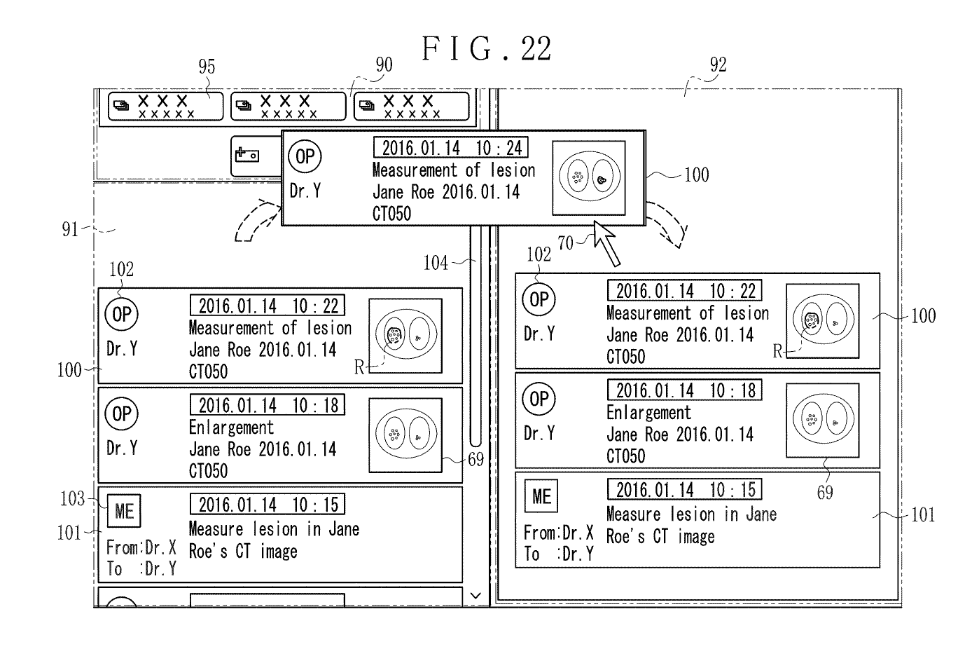

In FIG. 22, the activity display block 100 of the activity log data or the message display block 101 of the message data before association by the data manager 58 can be set to the group screen area 92 by drag and drop with the cursor 70, among the activity display block 100 and the message display block 101 in the timeline screen area 91. The activity display block 100 and the message display block 101 settable to the group screen area 92 by the drag and drop are limited to the activity display block 100 of the activity log data of an activity of a medical worker during the access to the medical support apparatus 13, or the message display block 101 of the message data sent by the medical worker during the access to the medical support apparatus 13.

In FIG. 22, the activity display block 100 of the activity log data for the activity type of “Measurement of lesion” with the activity log ID of OP005 in FIG. 10 is set in the group screen area 92 after the user activity of drag and drop.

Assuming that the add button 111 (association) is selected (pressed) with the cursor 70 after drag and drop of the activity display block 100 and the message display block 101 in the timeline screen area 91 to the group screen area 92, then an association request is sent by the browser control unit 46 to the request receiver 55. In short, the activity of the drag and drop of the activity display block 100 and the message display block 101 in the timeline screen area 91 to the group screen area 92 and the activity of selecting the add button 111 correspond to the association request.

Various IDs are associated with the association request, including the activity log ID of the activity log data of the activity display block 100 set by drag-and-drop, or the message ID of the message data of the message display block 101 set by drag-and-drop, and the envelope ID of the envelope of the envelope display block 95 selected in the envelope screen area 90. Assuming that the cancel button 112 is selected with the cursor 70, the form of the group screen area 92 is returned to a state before performing the drag-and-drop of the activity display block 100 and the message display block 101.

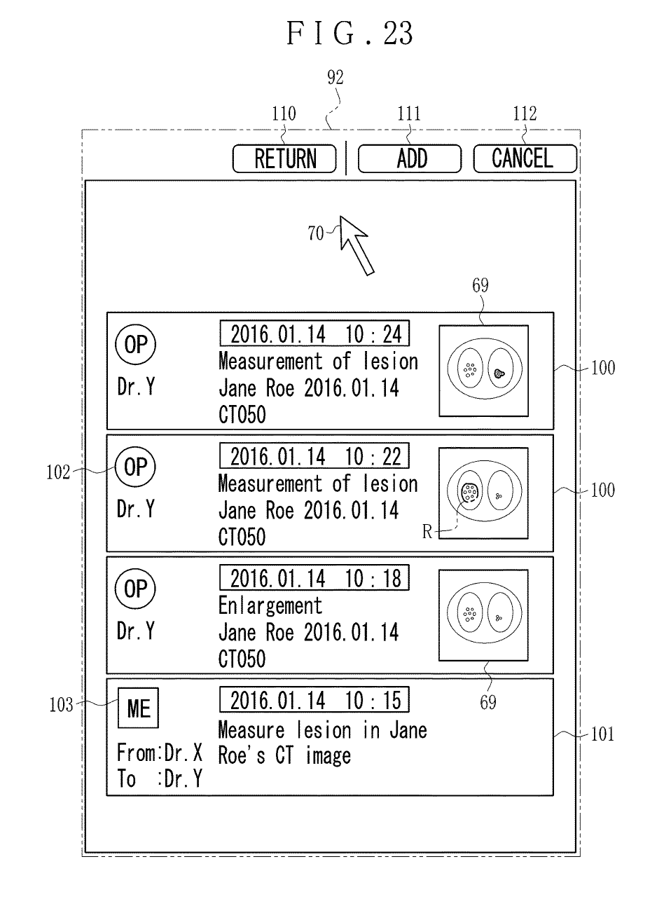

In FIG. 23, a display form of the group screen area 92 is illustrated, in a condition where the activity log data of the activity log ID of OP005 is associated by the data manager 58, as the activity display block 100 of the activity log data of the “Measurement of lesion” with the activity log ID of OP005 of FIG. 22 is set after the drag and drop from a condition of FIG. 21. In FIG. 23, the activity display block 100 of the activity log data of the activity log ID of OP005 is displayed in the uppermost row, in addition to the message display block 101 of the message data of the message ID of ME003 and the activity display block 100 of the activity log data of the activity log IDs of OP003 and OP004 in the manner of FIG. 21.

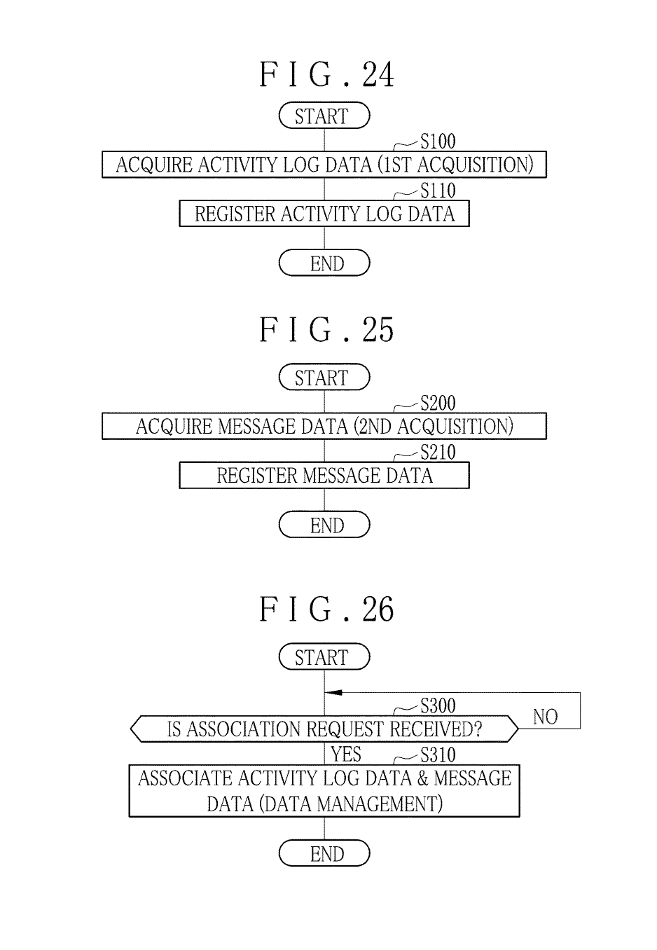

The operation of the above construction is described now by referring to flows in FIGS. 24-27. At first, a doctor or medical worker performs access to the medical support apparatus 13 with the display terminal apparatus 12, to perform the communication connection by establishment of authorization. To this end, he or she inputs his or her medical worker ID and an authorization key. After the authorization, the request receiver 55 in the medical support apparatus 13 receives various requests from the display terminal apparatus 12.

In FIG. 24, the first acquisition unit 56 in the medical support apparatus 13 acquires the activity log data in a step S100 or first acquisition step. The acquired activity log data is transferred to the data manager 58, which registers the same to the activity log data table 51 in a step S110.

The activity log data is registered in case the thumbnail image 69 in the combined screen 30 is selected with the cursor 70, for example, in case an input for displaying the diagnostic image in enlargement is performed, and in case the measure button 79 in the viewer screen 75 is selected with the cursor 70, namely, in case an input for measuring a lesion in the diagnostic image is performed. It is possible to distinguish the activity log data according to the activity type (process) of the user activities, to track the progress of the medical care with details. Particularly in case there are plural lesions in the diagnostic image, the data of each one of the user activities of measuring the lesions is registered as one activity log data. The activity log data for “Measurement of lesion” can be discerned for the lesions. The progress can be tracked precisely.

In FIG. 25, the second acquisition unit 57 acquires message data in a step S200 or second acquisition step. The acquired message data is transferred to the data manager 58, which registers the same to the message data table 52 in a step S210.

In case the request receiver 55 receives the association request in FIG. 26 (yes in a step S300), the data manager 58 associates the activity log data with the message data in a step S310. Specifically, the data manager 58 registers the envelope ID in the association request to a list item of the envelope ID of the activity log data of the activity log ID in the association request, or to a list item of the envelope ID of the message data of the message ID in the association request.

To generate the association request, the activity display block 100 of the activity log data or the message display block 101 of the message data without the association in the data manager 58 in the timeline screen area 91 is set in the group screen area 92 by the drag and drop. The add button 111 (association) is selected (pressed) with the cursor 70, to generate the association request. It is possible to associate the activity log data with the message data with great ease and direct manipulation.

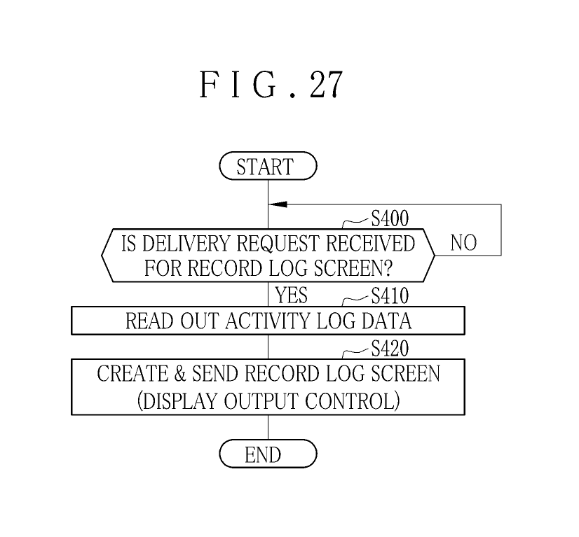

In case the request receiver 55 receives a delivery request for the record log screen 31 in FIG. 27 (yes in a step S400), the data manager 58 reads out activity log data from the activity log data table 51, message data from the message data table 52, and envelope data from the envelope data table 53 in a step S410 with requirement for creating the record log screen 31. Those data being read out are sent to the display output control unit 60.

In a step S420, the display output control unit 60 creates the record log screen 31 according to the activity log data, message data and envelope data, which is sent to the display terminal apparatus 12 as a requester of the delivery request. This step is a display output control step.

The delivery request for the record log screen 31 is generated by positioning the cursor 70 at the menu tag 85 indicated in the combined screen 30. It is possible for a medical worker to view the record log screen 31 easily as required at the same time as he or she views the combined screen 30, with advantage in the use in the medical care.

In the display terminal apparatus 12 as a requester of the delivery request for the record log screen 31, the record log screen 31 from the medical support apparatus 13 is displayed on the second display panel 21 together with the combined screen 30.

The envelope display block 95 is indicated in the envelope screen area 90 (group list screen area) of the record log screen 31. The activity display block 100 and the message display block 101 are indicated in a time sequence in the timeline screen area 91. Various data are indicated in the group screen area 92, including the activity log data and message data in the envelope of the envelope display block 95 selected with the envelope screen area 90, namely, the activity display block 100 of the activity log data and the message display block 101 of the message data associated by the data manager 58.

It is possible easily to recognize a causal relationship between the message and the user activity performed by referring to the message, as the activity display block 100 of the activity log data and the message display block 101 of the message associated together by the data manager 58 are displayed entirely in the group screen area 92. Review of the progress can be performed by doctors and the like with high efficiency, as the medical care can be tracked suitably.

It is possible with the timeline screen area 91 to grasp an activity type of an activity and a name of a medical worker having performed the activity, and to grasp a message and names of medical workers having exchanged the message. Thus, the overview of a workflow of each of the medical workers can be seen and understood by managers of the medical facility upon viewing the timeline screen area 91.

The envelope display block 95 is displayed in the envelope screen area 90. The activity display block 100 of the activity log data and the message display block 101 of the message data are displayed in the group screen area 92 in relation to the envelope of the envelope display block 95 selected in the envelope screen area 90. Thus, it is possible for a medical worker to perform access to the activity log data and the message data related to his or her group with great ease rapidly.

Assuming that a medical worker wishes to remove the envelope display block 95 in the envelope screen area 90, he or she clicks the right-side mouse button of the mouse by positioning the cursor 70 at the envelope display block 95, and selects the option of REMOVE in the editing/removal dialog box 98 with the cursor 70. Thus, the envelope display block 95 is removed. It follows that the envelope display block 95 of the envelope, which has become unnecessary after hospital discharge of the patient or after termination of a medical training workshop for the image interpretation, can be removed immediately by manipulation of the medical worker.

The medical support system 10 has the EMR terminal apparatus 11 in which the first display panel 20 displays the EMR screen 25. It is possible to view the EMR screen 25 on the first display panel 20 and the EMR terminal apparatus 11 and simultaneously to view the combined screen 30 and the record log screen 31 on the second display panel 21 of the display terminal apparatus 12. Thus, the review of the progress can be efficient, because switching between display screens can be unnecessary unlike the use of a single display panel for simultaneously displaying the EMR screen 25, the combined screen 30 and the record log screen 31. Furthermore, areas of the EMR screen 25, the combined screen 30 and the record log screen 31 can be kept large by use of the plural display panels. The display terminal apparatus 12, which has been conventionally used only for viewing the image screen 26, can be utilized also for the combined screen 30 and the record log screen 31 in the present invention, so that even the idle apparatus in the medical support system can be utilized effectively for medical care.

The combined screen 30 and the record log screen 31 of FIGS. 13 and 16 are formed in a layout according to the horizontally long display form. However, the combined screen 30 and the record log screen 31 can be rearranged or modified in a layout suitable for view in the second display panel 21 of a vertically long display form in the display terminal apparatus 12.

### Second Embodiment

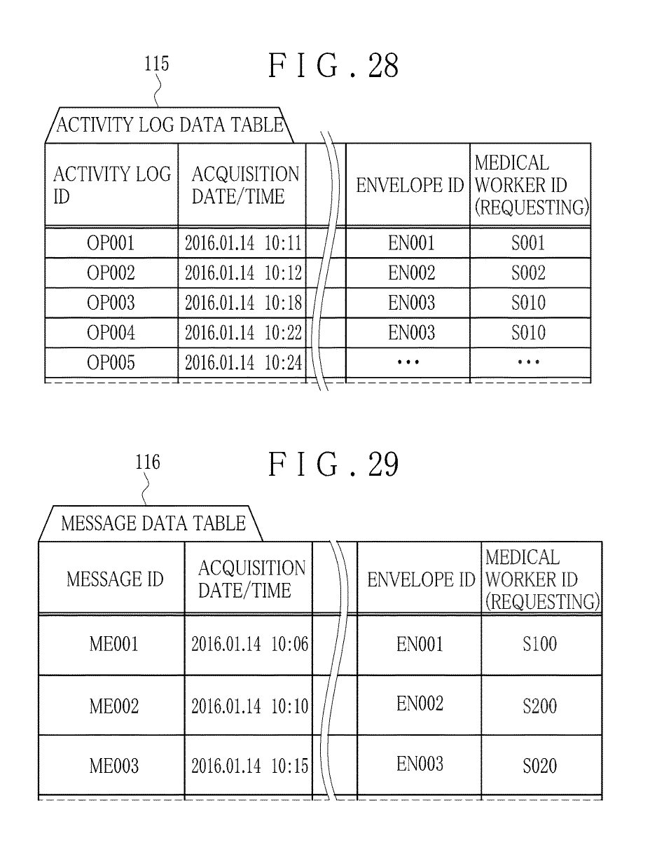

In FIGS. 28-30, a second preferred embodiment is illustrated, in which information associated by a medical worker during access to the medical support apparatus 13 is displayed in the group screen area 92 in a distinct display form from information associated by a medical worker different from the medical worker during access to the medical support apparatus 13.

In FIGS. 28 and 29, an activity log data table 115 and a message data table 116 of the embodiment are illustrated. A list item of the requesting medical worker ID (requesting user) is provided in the activity log data table 115 and the message data table 116 in addition to the list items of the first embodiment. In the list item of the requesting medical worker ID (requesting user), the requesting medical worker ID of the medical worker after performing the association request for the activity log data or the message data is registered. The requesting medical worker ID registered in the list item of the requesting medical worker ID (requesting user) is the input requesting medical worker ID in the course of the authorization, and becomes treated together with the association request.

For the list items omitted from depiction in FIGS. 28 and 29, the same list items as the activity log data table 51 and the message data table 52 in FIGS. 10 and 11 are registered, inclusive of the operator medical worker ID (operator user), image ID, activity type of a user activity, the sender medical worker ID (sender user), the recipient medical worker ID (recipient user), and text of the message.

The display output control unit 60 performs display processing of a first block and a second block in a distinct display form according to the medical worker ID input in the course of the authorization and the medical worker ID registered in the list item of the requesting medical worker ID (requesting user) in the activity log data table 115 and the message data table 116, the first block being the activity display block 100 of the activity log data or the message display block 101 of the message data after association request performed by a medical worker in the access to the medical support apparatus 13, the second block being the activity display block 100 of the activity log data or the message display block 101 of the message data after association request performed by a medical worker different from the medical worker in the access to the medical support apparatus 13.

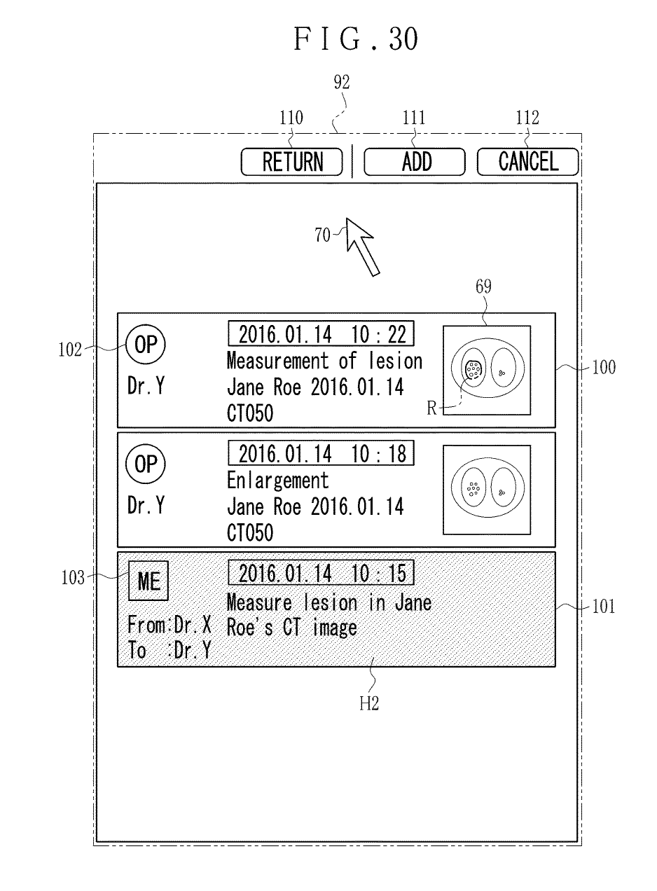

In FIG. 30, the message display block 101 of the message data with the message ID of ME003 and the message display block 101 of the activity log data with the activity log IDs of OP003 and OP004 are indicated together in the group screen area 92 in a time sequence in the same manner as FIG. 21. In this condition, the medical worker with the medical worker ID of S202 performs access to the medical support apparatus 13.

The message display block 101 of the message data of the message ID of ME003 corresponds to the message display block 101 of the message data for which the medical worker performing access to the medical support apparatus 13 has given an association request. The activity display block 100 of the activity log data of the activity log IDs of OP003 and OP004 corresponds to the activity display block 100 of the activity log data for which the medical worker different from the person performing the access to the medical support apparatus 13 has given an association request.

The display output control unit 60 performs display processing to indicate the message display block 101 of the message data with the message ID of ME003 in a distinct display form from the activity display block 100 of the activity log data with the activity log IDs of OP003 and OP004. Examples of the distinct display form are a relatively dark color for the display color as indicated by the hatched portion H2 (highlighted position), a winking form, a bold font for the letters, and other forms of emphasis.

Thus, the first block, which is the activity display block 100 of the activity log data or the message display block 101 of the message data after association request performed by a medical worker in the access to the medical support apparatus 13, can be distinguished easily from the second block being the activity display block 100 of the activity log data or the message display block 101 of the message data after association request performed by a medical worker different from the medical worker in the access to the medical support apparatus 13. The activity type of the activity and message by a medical worker by himself or herself can be discerned readily in a clarified display form.

Note that it is possible visually to emphasize the activity display block 100 of the activity log data or the message display block 101 of the message data of the association request performed by a second medical worker different from the medical worker performing access to the medical support apparatus 13, in the manner opposite to that in FIG. 30. Furthermore, an auxiliary indication method for a distinct display form can be used in addition to or in place of the emphasized display form of FIG. 30. For example, it is possible to enlarge an area of display of the activity display block 100 of the activity log data or the message display block 101 of the message data of the association request performed by the medical worker performing access to the medical support apparatus 13. Also, it is possible to display a frame line for entirely surrounding the activity display block 100 of the activity log data or the message display block 101 of the message data of the association request performed by the medical worker performing access to the medical support apparatus 13.

### Third Embodiment

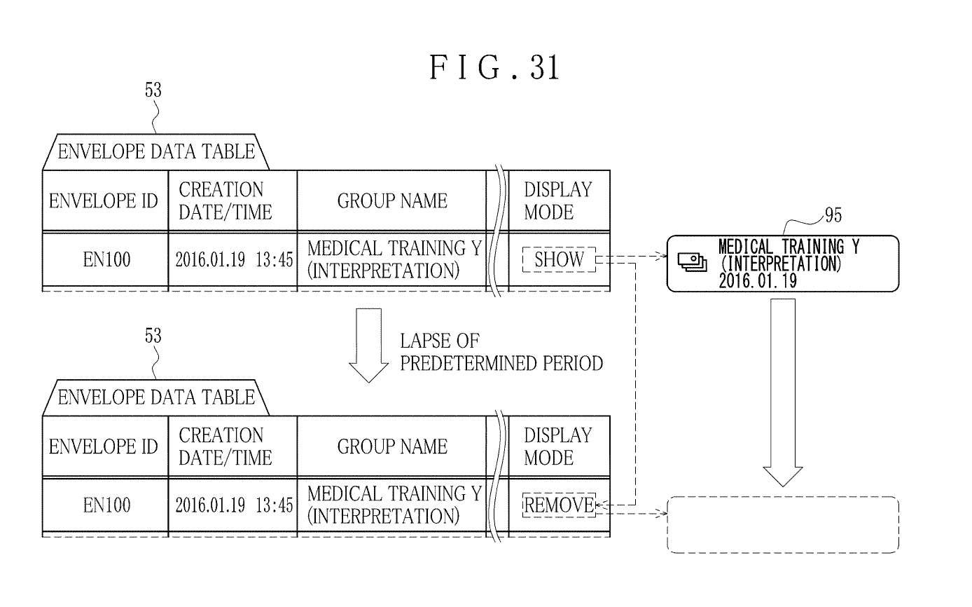

In contrast with the first embodiment in which the envelope display block 95 is removed by the user activity with the cursor 70, the envelope display block 95 in FIG. 31 is removed according to a display period in the record log screen 31.

The data manager 58 monitors the display period in the record log screen 31 in respectively the envelope display block 95. The display period is a difference obtained by subtracting creation date/time information registered in the envelope data table 53 from current date/time information. In case the display period becomes longer than a predetermined period, for example, one week, then the data manager 58 changes the list item of the display mode of the envelope data from “Show” to “Hide”.

In an example illustrated in FIG. 31, a list item of the display mode of the envelope data of the envelope ID of EN100 is changed from “Show” to “Hide” in case the display period becomes longer than the predetermined period. The display output control unit 60 performs display processing to display the envelope display block 95 with the registered display mode of “Show” in the list item, and to remove the envelope display block 95 with the registered display mode of “Hide” in the list item. The envelope display block 95 of the envelope of the envelope ID of EN100, which is indicated before the display period becomes longer than the predetermined period, is automatically removed in case the display period becomes longer than the predetermined period, as indicated by the dotted line.

Thus, the envelope display block 95 can be automatically removed without manual input of the medical worker, because the envelope display block 95 is removed according to the display period in the record log screen 31.

Note that the predetermined period may not be constant, but can be settable by a user activity of the medical worker upon creating an envelope. Also, a dialog box can be displayed to ask the medical worker whether the envelope display block 95 should be removed or not in case the display period becomes longer than the predetermined period.

### Fourth Embodiment

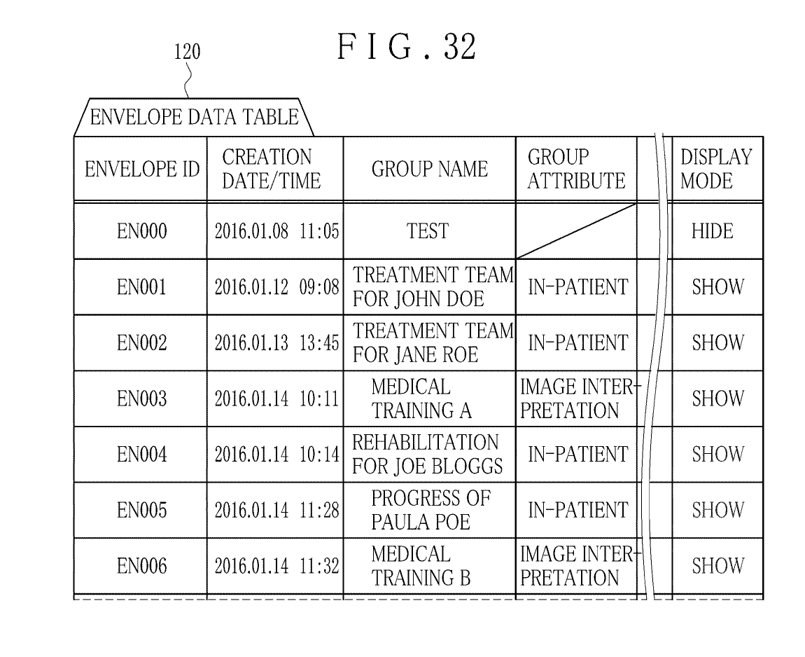

In FIGS. 32-34, a fourth preferred embodiment is illustrated, in which the envelope display block 95 is removed according to the attribute of the group.

In FIG. 32, an envelope data table 120 or messaging group data table includes a list item of a group attribute in addition to the list items according to the first embodiment. An attribute of a group corresponding to each envelope is registered in the list item of the group attribute. Examples of the group attribute includes “In-patient” for a group related to an in-patient for the purpose of treatment or the like, and “Image interpretation” for a group related to image interpretation for the purpose of a medical training workshop or the like. The group attribute is input together with the group name and the like in the creation page for the envelope, and associated with a creation request for the envelope.

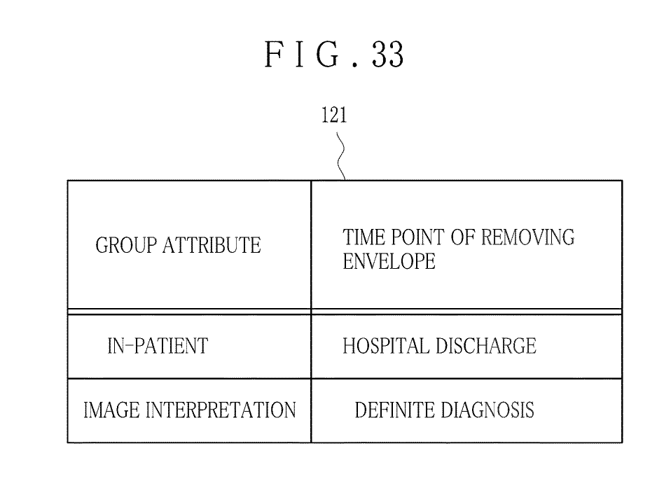

In FIG. 33, an auxiliary data table 121 stored in the storage medium 35B for removal contains registered data of time points for removing an envelope for respective group attributes. A group attribute of “In-patient” is associated with a registered time point of “Event of Hospital discharge” for removing an envelope. A group attribute of “Image interpretation” is associated with a registered time point of “Event of Definite diagnosis” for removing an envelope. Note that the term of the definite diagnosis is used to mean final diagnosis of a disease name of the particular patient by his or her attending doctor (attending physician). Occurrence of the hospital discharge and the definite diagnosis related to the patient can be recognized by reading the EMR data 18.

The data manager 58 changes the list item in the display mode in the envelope data table 120 according to the auxiliary data table 121. In case the patient is discharged in the hospital discharge, the list item in the display mode for the envelope data with “In-patient” of the group attribute is changed from the “Show” to “Hide”. In case a definite diagnosis is given to the patient, the list item in the display mode for the envelope data with “Image interpretation” of the group attribute is changed from “Show” to “Hide”.

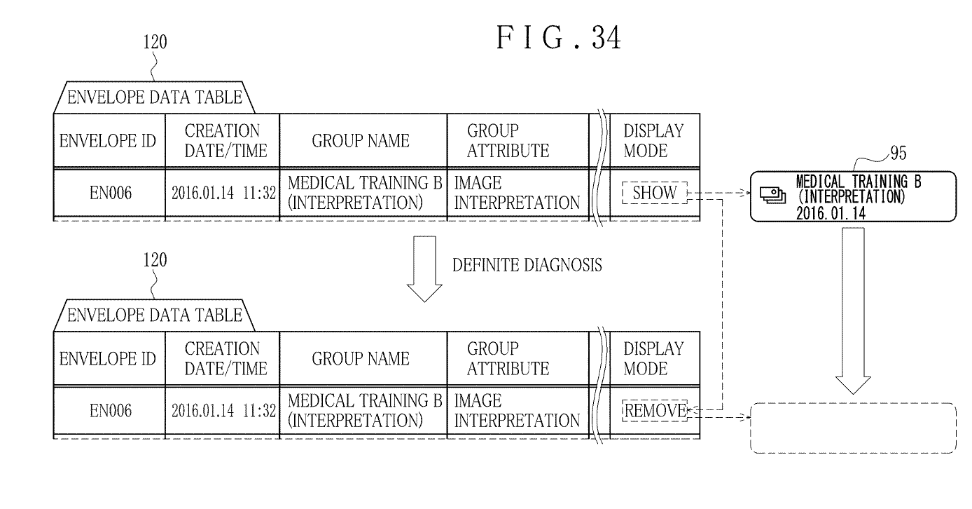

In FIG. 34, an example is illustrated, in which the list item of the display mode of the envelope data of the group attribute of “Image interpretation” with the envelope ID of EN006 is changed from “Show” to “Hide” upon occurrence of the definite diagnosis. The envelope display block 95 of the envelope of the envelope ID of EN006 is automatically removed upon the definite diagnosis as indicated by the dotted line.

Thus, it is possible automatically to remove the envelope display block 95 without manual handling of a medical worker, in the same manner as the third embodiment. The envelope display block 95 can be removed immediately upon occurrence of unnecessity in the group.

Also, the examples of the group attributes can include not only “In-patient” and “Image interpretation” described above but also “Out-patient” for a group of out-patients. A time point of removing the envelope with the group attribute of “Out-patient” (Follow-up visit) can be an event of determining a planned follow-up visit of the out-patient, or an event of payment for the medical service. Furthermore, it is possible to set a time point of removing an envelope changeable according to a period from the latest patient visit to next planned event of the patient visit. For example, assuming that an interval between the latest patient visit and next planned patient visit is less than a predetermined interval, then the envelope may be displayed without removal. Assuming that the interval between the latest patient visit and next planned patient visit is equal to or more than the predetermined interval, then the envelope may be removed in the event of the payment.

### Fifth Embodiment

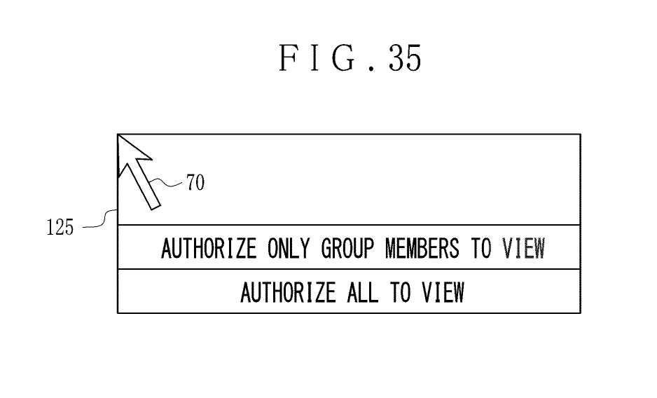

In FIGS. 35-38, authorization data for authorization of reading the activity log data is acquired, to control display of the activity log data according to the authorization data.

An authorization dialog box 125 of FIG. 35 is displayed on the combined screen 30 upon a user activity related to a test result, for example, in case the thumbnail image 69 of a diagnostic image is selected with the cursor 70, or in case the measure button 79 in the viewer screen 75 is selected with the cursor 70.

The authorization dialog box 125 is used for determining authorization of viewing the activity log data of the performed user activities. Two options are predetermined in the authorization dialog box 125, including an option of registered medical workers (hereinafter referred to as member medical workers) of which a medical worker ID is registered in the list item of the member medical worker ID (member user) in the envelope data table 53, and an option of all the medical workers in the medical facility. A selected one of the options is associated by the browser control unit 46 with the registration request for the activity log data as authorization data after the selection in the authorization dialog box 125 with the cursor 70.

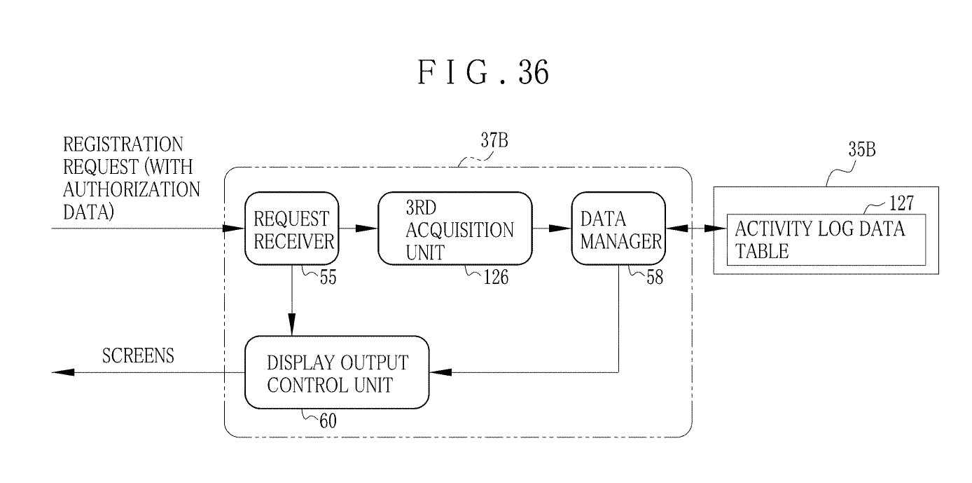

In FIG. 36, a third acquisition unit 126 is established in the CPU 37B of the medical support apparatus 13 in addition to the request receiver 55, the first acquisition unit 56, the second acquisition unit 57, the data manager 58, the medical data acquisition unit 59 and the display output control unit 60 of the first embodiment. The request receiver 55 sends the registration request for the activity log data to the third acquisition unit 126, inclusive of the authorization data. The third acquisition unit 126 acquires the authorization data included in the registration request for the activity log data from the request receiver 55, and transfers the authorization data to the data manager 58.

The data manager 58 registers authorization data from the third acquisition unit 126 to an activity log data table 127. In response to the delivery request for the record log screen 31, the data manager 58 reads out the activity log data from the activity log data table 127 inclusive of the authorization data, and sends the activity log data to the display output control unit 60. In FIG. 36, several circuit devices are omitted from the depiction, such as the first acquisition unit 56, the second acquisition unit 57, the medical data acquisition unit 59, the message data table 52 and the envelope data table 53.

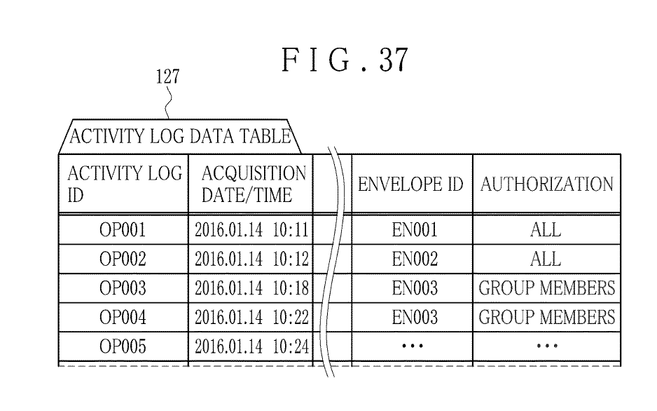

In FIG. 37, the activity log data table 127 of the embodiment includes a list item of authorization for registering the authorization data in addition to the list items of the first embodiment. In the list item of the authorization, the data manager 58 registers “Group members” assuming that the option of the group members is selected in the authorization dialog box 125 to designate the group members in the authorization data, and registers “All” assuming that the option of all the users is selected in the authorization dialog box 125 to designate all the users in the authorization data.

In FIG. 37, the authorization mode of viewing the activity log data of the activity log IDs of OP001 and OP002 is “All”. The authorization mode of viewing the activity log data of the activity log IDs of OP003 and OP004 is “Group members”. Note that the same data as those in the activity log data table 51 in FIG. 10 for the first embodiment are registered in list items of the operator medical worker ID (operator user), the image ID and the activity type which are not shown in FIG. 37.

The display output control unit 60 controls display of the activity log data according to the authorization data. Specifically, the activity display block 100 of the activity log data, of which “Group members” is registered in the list item of the authorization, is displayed in the timeline screen area 91 while a group member performs access, and is undisplayed while a medical worker other than the group members performs access.

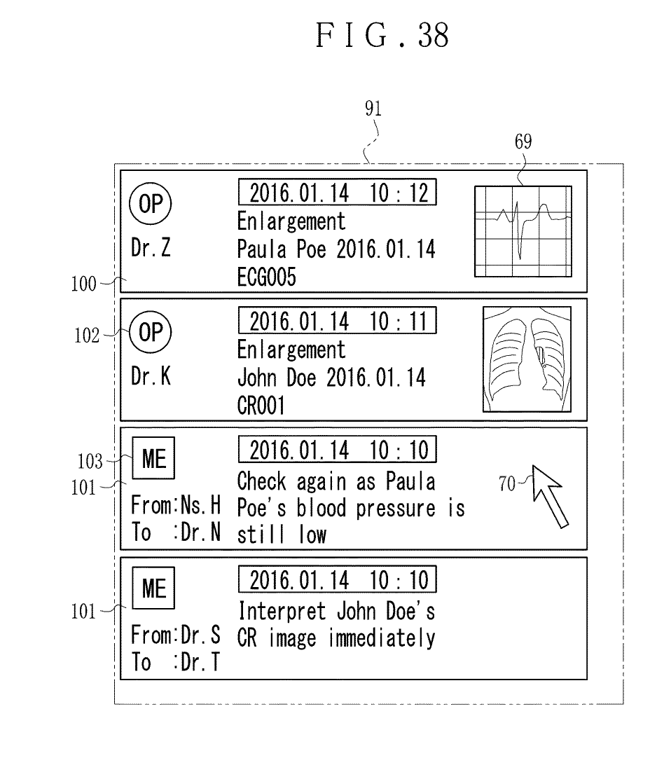

In FIG. 37, the activity log data of the activity log IDs of OP003 and OP004 of which “Group members” is registered in the list item of the authorization is included in the envelope of the envelope ID of EN003. Assuming that a medical worker other than the group members of the envelope of the envelope ID of EN003 (namely, except for those with the medical worker IDs of S010 and S020) performs access to the medical support apparatus 13 to display the record log screen 31, then the activity display block 100 of the activity log data of the activity log IDs OP003 and OP004 is set undisplayed (hidden) in the timeline screen area 91. See FIG. 38. Assuming that one of the group members of the envelope of the envelope ID of EN003 performs access to the medical support apparatus 13, then the screen in FIGS. 19 and 20 in the first embodiment is displayed.

Thus, the record log screen 31 can have a clarified form by limiting the authorization to the group members for activity log data only for share between the group members, because the activity display block 100 of the activity log data unrelated to medical workers different from the group members is kept undisplayed. It is possible for the group members easily to give an association request or the like, because the activity display block 100 of the activity log data related to the group members is displayed necessarily. This construction is particularly useful for the purpose of exchanging messages of high confidentiality, for example, communication related to the patient condition of the particular patient.

Note that statuses of authorization can be predetermined more finely for plural access rights, for example, an access right to particular medical workers among the group members, and an access right to the group members and a department manager of a hospital department other than the group members among the numerous medical workers, and an access right to only department managers of hospital departments, and the like. Also, access rights can be determined according to an attribute of a medical worker having performed the user activity, for example, a status of a trainee radiologist having performed the user activity can give the access right to all of the radiologists in the same department for image interpretation, and also a status of a department manager having performed the user activity can give the access right to all of the medical workers in the same department. Furthermore, an access right for viewing message data can be settable in addition to the activity log data.

### Sixth Embodiment

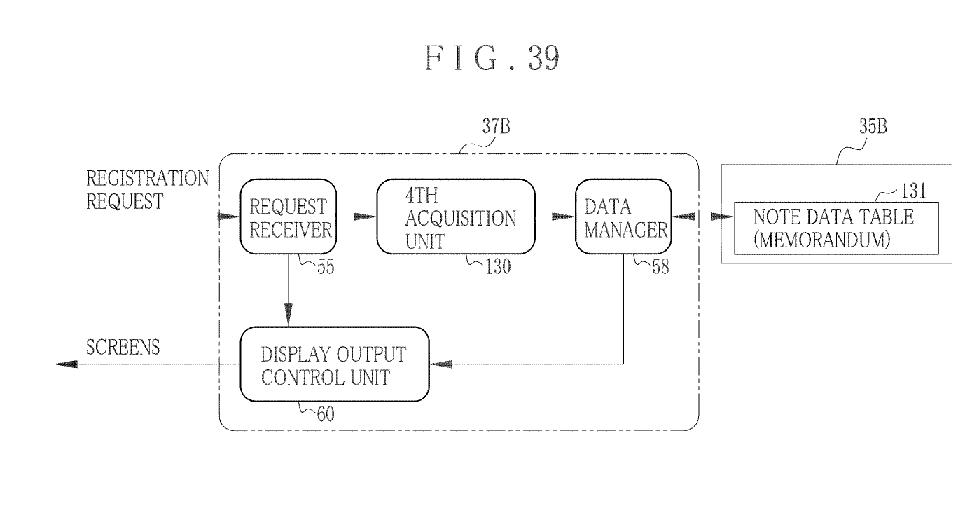

In FIGS. 39-41, note data of note text (memorandum) which a doctor has recorded for self-reporting is acquired, and is displayed in the group screen area 92 together with the activity log data and the message data.

In FIG. 39, a fourth acquisition unit 130 is established in the CPU 37B of the medical support apparatus 13 in addition to the request receiver 55, the first acquisition unit 56, the second acquisition unit 57, the data manager 58, the medical data acquisition unit 59 and the display output control unit 60 of the first embodiment. The request receiver 55 sends the registration request for the note data to the fourth acquisition unit 130. After inputting the note text in the input page for the messages, the registration request for the note text is sent from the browser control unit 46 to the request receiver 55 upon selecting the send button with the cursor 70 without inputting the recipient medical worker ID (recipient user). The fourth acquisition unit 130 acquires the note data included in the registration request in the note data from the request receiver 55, and transfers the note data to the data manager 58.

A note data table 131 or memorandum data table or alert data table is stored in the storage medium 35B, to which the data manager 58 registers the note data from the fourth acquisition unit 130. Also, the data manager 58 reads out the note data from the note data table 131 in response to the delivery request for the record log screen 31, and sends the note data to the display output control unit 60. Note that various circuit devices are omitted from FIG. 39 in the same manner as FIG. 36, including the first acquisition unit 56, the second acquisition unit 57, the medical data acquisition unit 59, the activity log data table 51, the message data table 52, the envelope data table 53 and the like.

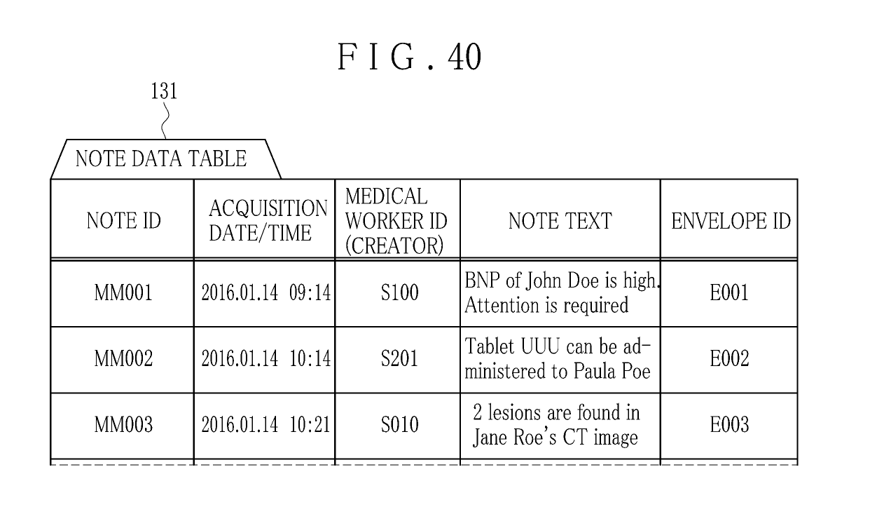

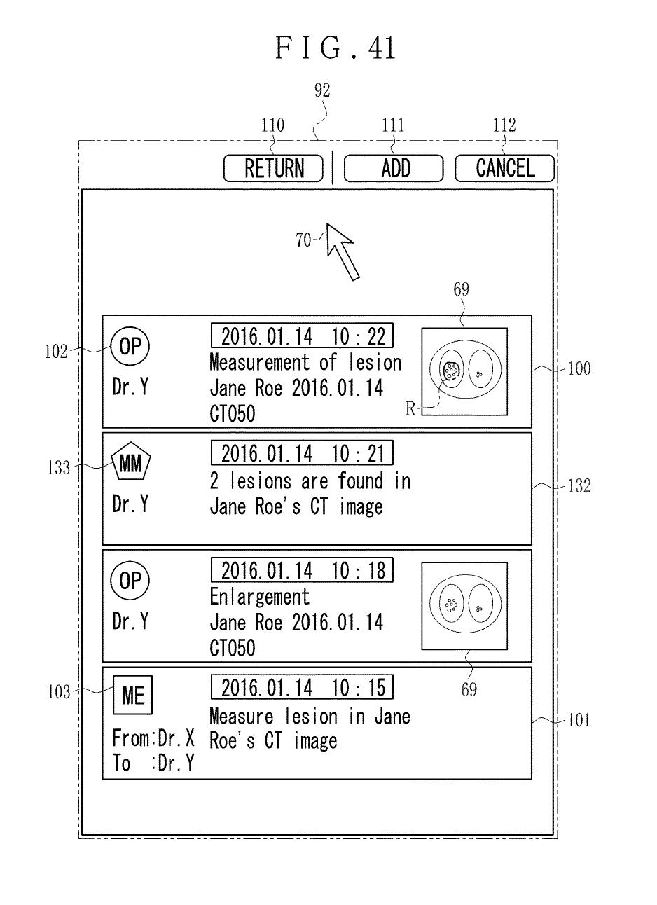

In FIG. 40, examples of list items in the note data table 131 are a note ID, date/time information of acquisition, creator medical worker ID (creator user), text and envelope ID.

The note ID is signs and/or numbers for identifying each of the note data. The note ID is automatically added upon registering the note data in the similar manner to the activity log ID. In the list item of the acquisition date/time information, the date/time information of acquisition of the note data in the fourth acquisition unit 130 is registered. In the list item of the creator medical worker ID (creator user), the medical worker ID of the medical worker as a creator of the note data is registered. The medical worker ID for registration to the list item of the creator medical worker ID (creator user) is the medical worker ID input upon the authorization in the same manner as the operator medical worker ID (operator user).

The text of the note data is registered for a list item of the text. For example, the note data of the note ID of MM001 includes the registered text of “BNP of John Doe is high. Attention is required”, to encourage attention to the patient condition, BNP being brain natriuretic peptide. The note data of the note ID of MM003 includes the registered text of “2 lesions are found in Jane Roe's CT image”, as a finding in the course of image interpretation.

The note data is also associated with the activity log data and the message data by use of the envelope ID. The envelope ID of the envelope containing the particular note data which has been associated by the data manager 58 is registered in the list item of the envelope ID, in the same manner as the activity log data table 51. In contrast, no envelope ID, in relation to the note data without being associated by the data manager 58, is registered in the list item of the envelope ID. Note that the registration request for the note data includes the creator medical worker ID (creator user) and text among the list items in the note data table 131.

The combined screen 30 performs display processing of a note display block (or note screen view hereinafter referred to as MM block) of the note data in the record log screen 31 in addition to the activity display block 100 and the message display block 101. The note display block in the timeline screen area 91 can be set to the group screen area 92 by drag and drop in the same manner as the activity display block 100 and the message display block 101 in the first embodiment. The note data, the activity log data and the message data can be associated together by the drag and drop.

In FIG. 41, an example of a form of the group screen area 92 is illustrated. A note display block 132 (or note screen view) or MM block or memorandum display block or alert display block is indicated in the group screen area 92, in addition to the message display block 101 of the message data with the message ID of ME003 and the activity display block 100 of the activity log data with the activity log IDs of OP003 and OP004, which are associated by use of the envelope ID of EN003. The note display block 132 is indicated in a color different from the color of the activity display block 100 and the message display block 101. A letter code 133 or mark of MM is indicated in the note display block 132 with a pentagonal line around the letters.

Thus, displaying the note data in the group screen area 92 in addition the activity log data and message data makes it possible easily to grasp a causal relationship between the note data and the other data in addition to the causal relationship between the activity and the message. The progress of the medical care can be tracked suitably and efficiently.

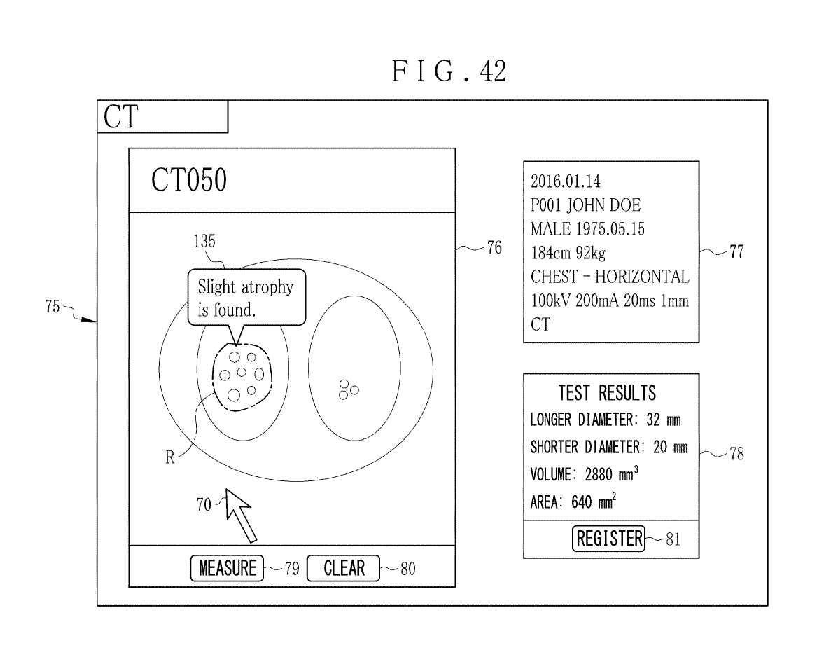

In the above embodiment, the user activities related to the test results are the user activity of selecting the thumbnail image 69 of the image with the cursor 70, and the user activity of selecting the measure button 79 in the viewer screen 75 with the cursor 70. However, the present invention is not limited thereto. In FIG. 42, an activity of adding an annotation text 135 in a popup area to a diagnostic image in the image window 76 can be an activity related to the test result in the viewer screen 75.

In the above embodiments, the test results of the diagnostic tests are diagnostic images of medical imaging. However, test results can be those of diagnostic tests other than the medical imaging, such as the vital sign measurement, blood test, urinalysis and the like. In this structure, user activities related to the test results are those for enlarging the display window of a list of test values of the blood test in the combined screen 30.

Furthermore, an input of instruction for the delivery request for the image screen 26 from the display terminal apparatus 12 to the image server apparatus 16 can be regarded as an activity related to a test result instead of the activity in the combined screen 30 and the viewer screen 75. Also, the image screen 26 may have a function of measuring a lesion in the same manner as the viewer screen 75. The activity of measuring the lesion in the image screen 26 can be regarded as an activity related to a test result.

Assuming that the user activities related to the image screen 26 are regarded as user activities to the test results, it is possible to send a registration request of the activity log data to the medical support apparatus 13 through the image server apparatus 16, instead of sending a registration request of the activity log data to the medical support apparatus 13 directly from the display terminal apparatus 12.

In the first embodiment, the activity display block 100 and the message display block 101 settable to the group screen area 92 by the drag and drop are limited to the activity display block 100 of the activity log data of an activity of a medical worker during the access to the medical support apparatus 13, or the message display block 101 of the message data sent by the medical worker during the access to the medical support apparatus 13. However, other objects of the activity display block 100 and the message display block 101 can be settable to the group screen area 92 by the drag and drop, including the activity display block 100 of the activity log data of an activity of a medical worker different from the medical worker during the access to the medical support apparatus 13, or the message display block 101 of the message data sent by a medical worker different from the medical worker during the access to the medical support apparatus 13.

In the first embodiment, the examples of the user activities of the association request are the user activity of drag and drop of the activity display block 100 and the message display block 101 from the timeline screen area 91 to the group screen area 92 and the button input of selecting the add button 111 (association). However, the user activity of the association request can be only the user activity of drag and drop of the activity display block 100 and the message display block 101 from the timeline screen area 91 to the group screen area 92 without use of the button input of selecting the add button 111. Also, a user activity of the association request can be only a user activity of drag and drop of the activity display block 100 and the message display block 101 from the timeline screen area 91 to the envelope display block 95 of the envelope screen area 90 (group list screen area) without use of the group screen area 92.

The association request may not have the user activity of the drag and drop. For example, a check box can be additionally indicated with the activity display block 100 and the message display block 101 in the timeline screen area 91, so that adding a check mark for the check box can be regarded as the association request. Also, a serial number can be indicated in the activity display block 100 and the message display block 101 in the timeline screen area 91, so that inputting the serial number can be regarded as the association request.

The display mode of the record log screen 31 of the above embodiments is only an example, and can be modified for purposes. For example, the envelope screen area 90 and the timeline screen area 91 can be displayed in a screen other than the record log screen 31. Also, the timeline screen area 91 can be formed in a form of layered tabs instead of the scrollable form. In the timeline screen area 91, assuming that the number of the activity display block 100 and the message display block 101 becomes excessively high beyond the displayable range with one tab, new tabs can be added, and overlapped on the initial uppermost tab.

Also, a medical worker having an access right for editing or removing the envelope display block 95 can be selectively predetermined in order to inhibit unauthorized editing and removal of the envelope display block 95. In this structure, the editing/removal dialog box 98 is displayed only assuming that the medical worker during the access to the medical support apparatus 13 is the medical worker having the access right for editing or removing the envelope display block 95.

In the above embodiments, the removal of the envelope means setting the envelope undisplayed (hiding) in the display screen without deleting the envelope data. The envelope can be redisplayed subsequently. However, it is possible in the removal to delete envelope data completely from the display screen. Redisplaying the envelope may be impossible after the deletion.

Hardware construction of the computer for constituting the medical support apparatus 13 of the present invention can be modified suitably. For example, the medical support apparatus 13 can be constituted by a plurality of server computers discrete from one another for the purpose of increasing performance of processing and reliability. Specifically, a first server computer may constitute the request receiver 55, the first acquisition unit 56 and the second acquisition unit 57. A second server computer may constitute the data manager 58. A third server computer may constitute the medical data acquisition unit 59 and the display output control unit 60. The medical support apparatus can be constituted by the three server computers.

In the first embodiment, the medical support apparatus 13 creates the combined screen 30 and the record log screen 31. The display terminal apparatus 12 drives the second display panel 21 to display the combined screen 30 and the record log screen 31 according to the display data of the combined screen 30 and the record log screen 31 from the medical support apparatus 13. However, it is possible to transmit medical care data as resource of the combined screen 30 and the record log screen 31 from the medical support apparatus 13 to the display terminal apparatus 12, and to create the combined screen 30 and the record log screen 31 in the display terminal apparatus 12. The display output control unit 60 is established in the CPU 37A in the display terminal apparatus 12.

Furthermore, circuit devices established in the CPU 37B in the medical support apparatus 13 can be established in the CPU 37A of the display terminal apparatus 12, which can operates as a medical support apparatus. To this end, the request receiver 55 directly receives command signals from the GUI control unit 45 in place of the delivery request or the like. Also, the display output control unit 60 outputs the combined screen 30 and the record log screen 31 to the GUI control unit 45. Note that the EMR server apparatus 15 or the image server apparatus 16 can be operated as a medical support apparatus.

Thus, the construction of the hardware in the computer can be changed suitably according to performance requiring ability for processing, safety, reliability and the like. Additionally, it is also possible to store the control program 50 and other application programs in a duplicated form or divided form in plural storage media for the purpose of ensuring the safety and the reliability.

In the above embodiments, the medical support apparatus 13 is used in one medical facility. However, it is possible to use the medical support apparatus 13 commonly in a plurality of medical facilities.

In the above embodiments, the display terminal apparatus 12 in one medical facility is connected to the medical support apparatus 13 communicably by use of the LAN 14 or other network. The medical support apparatus 13 delivers the combined screen 30 and the record log screen 31 of medical support in response to a request from the display terminal apparatus 12. To use the combined screen 30 and the record log screen 31 in the plural medical facilities, the medical support apparatus 13 is set on-line with the plural client terminal apparatuses 12 positioned in the medical facilities by use of the wide area network (WAN), such as the Internet, public communication network and the like. Requests from the client terminal apparatuses 12 of the medical facilities are received by the medical support apparatus 13 with the WAN, to deliver the combined screen 30 and the record log screen 31 of the medical support to the display terminal apparatus 12. Note that information security should be established for use of the WAN, for example, the Virtual Private Network (VPN) or Hypertext Transfer Protocol Secure (HTTPS) can be preferably used as communication protocol of a high level of security.

The EMR data 18, the image data 19, the activity log data, the message data and the envelope data are managed for each one of the medical facilities. A place of installation and manager of the medical support apparatus 13 can be a data center of a service provider (company) separate from the medical facilities, but can be a suitable one of the plural medical facilities.

The medical support apparatus of the invention can have at least a function of controlling the output of the record log screen 31. However, the medical support apparatus of the invention may not have a function of controlling the output of the combined screen 30 in the manner of the display output control unit 60. A recipient of the delivery of the record log screen 31 is not limited to the display terminal apparatus 12 in which the image screen 26 is displayed according to the above embodiments. A recipient of the delivery of the record log screen 31 can be a medical user terminal apparatus without displaying the image screen 26.

The present invention is not limited to the above embodiments. Various features of the embodiments and variants of the invention can be combined with each other suitably. Also, the computer-executable program and a storage medium for storing the computer-executable program are included in the scope of the present invention.

According to one embodiment mode of the invention, an operating method for a medical support apparatus includes a step of acquiring activity log data of a user activity related to a test result from a display terminal apparatus for displaying a test result of a diagnostic test performed to a patient body. Message data of a message transmitted between medical user terminal apparatuses from the medical user terminal apparatuses used by medical workers is acquired. The activity log data and the message data are registered to a storage medium in a manner associated with one another. Display control of a record log screen having a group screen area for displaying the activity log data and the message data together after being associated is performed.

According to a preferred embodiment mode of the invention, the display output control unit performs display of first and second activity log data in the group screen area. The first activity log data is associated by the association request of a first medical worker during access. The second activity log data is associated by the association request of a second medical worker different from the first medical worker, and has a display form distinct from the first activity log data.

Also, the display output control unit performs display of first and second message data in the group screen area. The first message data is associated by the association request of a first medical worker during access. The second message data is associated by the association request of a second medical worker different from the first medical worker, and has a display form distinct from the first message data.

Although the present invention has been fully described by way of the preferred embodiments thereof with reference to the accompanying drawings, various changes and modifications will be apparent to those having skill in this field. Therefore, unless otherwise these changes and modifications depart from the scope of the present invention, they should be construed as included therein.

What is claimed is:

1. A medical support apparatus comprising:
a first acquisition unit for acquiring activity log data of a user activity related to a test result from a display terminal apparatus for displaying a test result of a diagnostic test performed to a patient body;
a second acquisition unit for acquiring message data of a message transmitted between medical user terminal apparatuses from said medical user terminal apparatuses used by medical workers;
a data manager for registering said activity log data and said message data to a storage medium in a manner associated with one another; and
a display output control unit for performing display control of a record log screen having a group screen area for displaying said activity log data and said message data together after being associated by said data manager.

2. A medical support apparatus as defined in claim 1, wherein said first acquisition unit acquires said activity log data of said user activity of measuring a lesion in a diagnostic image formed by performing medical imaging of said patient body.

3. A medical support apparatus as defined in claim 2, wherein assuming that plural lesions are found in said diagnostic image, said first acquisition unit acquires one set of said activity log data from activity log data of plural user activities of measuring said plural lesions.

4. A medical support apparatus as defined in claim 1, wherein said record log screen includes a timeline screen area for displaying said activity log data and said message data in a time sequence.

5. A medical support apparatus as defined in claim 4, wherein said data manager associates said activity log data and said message data in response to an association request input by a medical worker with said timeline screen area.

6. A medical support apparatus as defined in claim 5, wherein said display output control unit displays said activity log data or said message data after being associated by said association request of said medical worker during access thereto in said group screen area in a distinct display form from said activity log data or said message data after being associated by said association request of a medical worker different from said medical worker during said access.

7. A medical support apparatus as defined in claim 5, wherein said association request is constituted by an activity of drag and drop of said activity log data and said message data in said timeline screen area to said group screen area.

8. A medical support apparatus as defined in claim 1, wherein said record log screen further includes an envelope screen area for indicating an envelope for grouping said activity log data and said message data by a unit of a group.

9. A medical support apparatus as defined in claim 8, wherein said activity log data and said message data grouped in said envelope selected in said envelope screen area are displayed in said group screen area.

10. A medical support apparatus as defined in claim 8, wherein said display output control unit performs removal of said envelope upon an input of said medical worker.

11. A medical support apparatus as defined in claim 8, wherein said display output control unit performs removal of said envelope according to a display period of displaying said envelope in said record log screen.

12. A medical support apparatus as defined in claim 8, wherein said display output control unit performs removal of said envelope according to an attribute of said group.

13. A medical support apparatus as defined in claim 1, further comprising a third acquisition unit for acquiring authorization data of authorization for access to said activity log data from said display terminal apparatus;
wherein said display output control unit performs display control of said activity log data according to said authorization data.

14. A medical support apparatus as defined in claim 1, further comprising an acquisition unit for acquiring note data of note text of said medical worker for self-reporting from said medical user terminal apparatus;
wherein said display output control unit performs display control of said note data in said group screen area in addition to said activity log data and said message data.

15. A non-transitory computer readable medium for storing a computer-executable program enabling execution of computer instructions to perform operations for medical support, said operations comprising:
acquiring activity log data of a user activity related to a test result from a display terminal apparatus for displaying a test result of a diagnostic test performed to a patient body;
acquiring message data of a message transmitted between medical user terminal apparatuses from said medical user terminal apparatuses used by medical workers;
registering said activity log data and said message data to a storage medium in a manner associated with one another; and
performing display control of a record log screen having a group screen area for displaying said activity log data and said message data together after being associated.

16. A medical support system including a medical support apparatus, a display terminal apparatus, connected to said medical support apparatus by use of a network, for displaying a test result of a diagnostic test to a patient body, and medical user terminal apparatuses, connected to said medical support apparatus by use of said network, and operated by a medical worker;
said medical support apparatus comprising:
a first acquisition unit for acquiring activity log data of a user activity related to said test result from said display terminal apparatus;
a second acquisition unit for acquiring message data of a message transmitted between medical user terminal apparatuses from said medical user terminal apparatuses;
a data manager for registering said activity log data and said message data to a storage medium in a manner associated with one another; and
a display output control unit for performing display control of a record log screen having a group screen area for displaying said activity log data and said message data together after being associated by said data manager.

17. A medical support system as defined in claim 16, further comprising:
an EMR terminal apparatus, connected with said network, for outputting a display screen of EMR data of an electronic medical record of a progress of said patient body;
an image display terminal apparatus, connected with said network, for outputting an image screen of image data of a diagnostic image obtained by performing imaging of said patient body;
wherein said display output control unit outputs said record log screen to said image display terminal apparatus;
said image display terminal apparatus outputs said record log screen to said second display panel in addition to said image screen.

18. A medical support system as defined in claim 17, wherein said display output control unit further outputs a combined screen of combined medical care data to said image display terminal apparatus by combining said EMR data and said image data;
said image display terminal apparatus further outputs said combined screen to said second display panel.

19. A medical support system as defined in claim 18, wherein said combined screen is constituted by a graphical user interface for requesting display of said record log screen.
